(19) United States
(12) Patent Application Publication
(10) Pub. No.: US 2026/0019131 A1
(43) Pub. Date: Jan. 15, 2026

(54) ENHANCED UPLINK TRANSMISSIONS FOR WIRELESS COMMUNICATIONS USING MORE THAN FOUR LAYERS

(71) Applicant: INTEL CORPORATION, Santa Clara, CA (US)

(72) Inventors: Guotong WANG, Beijing (CN); Bishwarup MONDAL, San Ramon, CA (US); Viktor SERGEEV, Dublin (IE)

(73) Assignee: INTEL CORPORATION, Santa Clara, CA (US)

(21) Appl. No.: 18/994,043

(22) PCT Filed: Aug. 11, 2023
(86) PCT No.: PCT/US2023/030077

§ 371 Date: Jan. 13, 2025

(30) Foreign Application Priority Data
Aug. 12, 2022 (WO) PCT/CN2022/112038
Sep. 30, 2022 (WO) PCT/CN2022/123232
Sep. 30, 2022 (WO) PCT/CN2022/123283

(51) Int. Cl. H04B 7/06; H04W 72/21; H04W 72/232

(52) U.S. Cl. CPC H04B 7/0639; H04W 72/21; H04W 72/232

(57) ABSTRACT

This disclosure describes systems, methods, and devices for configuring an uplink transmission for a user equipment device (UE) using eight transmitters. A network device may encode a precoder rank indicator for use in an eight-transmitter uplink transmission by a UE device; encode a precoder indicator, indicative of a precoder type, for use in the eight-transmitter uplink transmission by the UE device; and encode downlink control information (DCI) for transmission to the UE device, the DCI including the precoder rank and the precoder indicator.

### CROSS-REFERENCE TO RELATED PATENT APPLICATION(S)

This application claims the benefit of PCT Provisional Application No. PCT/CN2022/112038, filed Aug. 12, 2022, PCT Provisional Application No. PCT/CN2022/123283, filed Sep. 30, 2022, and PCT Provisional Application No. PCT/CN2022/123232, filed Sep. 30, 2022, the disclosures of which are incorporated herein by reference as if set forth in full.

### TECHNICAL FIELD

This disclosure generally relates to systems and methods for wireless communications and, more particularly, to uplink transmissions using more than four layers.

### BACKGROUND

Wireless devices are becoming widely prevalent and are increasingly using wireless channels. The 3^{rd} Generation Partnership Program (3GPP) is developing one or more standards for wireless communications.

### BRIEF DESCRIPTION OF THE DRAWINGS

FIG. 1 is a network diagram illustrating an example network environment, in accordance with one or more example embodiments of the present disclosure.

FIG. 2 illustrates an example portion of downlink control information (DCI) signaling used for precoding uplink transmissions, in accordance with one or more example embodiments of the present disclosure.

FIG. 3 illustrates a flow diagram of illustrative process for DCI signaling used for precoding uplink transmissions, in accordance with one or more example embodiments of the present disclosure.

FIG. 4. illustrates a network, in accordance with one or more example embodiments of the present disclosure.

FIG. 5 schematically illustrates a wireless network, in accordance with one or more example embodiments of the present disclosure.

FIG. 6 is a block diagram illustrating components, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wireless devices may operate as defined by technical standards. For cellular telecommunications, the 3^{rd} Generation Partnership Program (3GPP) define communication techniques, including precoders (e.g., transmit precoding matrix indices (TPMIs)) for uplink communications. Currently, 3GPP defines up to four layers for physical uplink shared channel (PUSCH) transmissions. The precoders for PUSCH transmissions are defined in 3GPP TS 38.211, depending on the rank value (e.g., number of layers), number of antenna ports and waveform (e.g., cyclic prefix orthogonal frequency division multiplexing or discrete Fourier transform spread orthogonal frequency division multiplexing). Table 1 shows the precoding matrix W for a single-layer transmission using two antenna ports.

TABLE 1
Precoding Matrix W for Single-Layer Transmission (Rank 1) Using Two
Antenna Ports

| TPMI Index | W (Ordered from left to right in increasing order of TPMI Index) | | | | | |
|---|---|---|---|---|---|---|
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ |

Table 2 shows the precoding matrix W for a two-layer transmission using two antenna ports with transform precoding disabled.

TABLE 2
Precoding Matrix W for Two-Layer Transmission (Rank 2) Using
Two Antenna Ports (cyclic prefix orthogonal frequency
division multiplexing)

| | W (Ordered from left to right in increasing order of | | |
|---|---|---|---|
| TPMI Index | TPMI Index) | | |
| 0-2 | $\frac{1}{\sqrt{2}} [ \begin{matrix}1 & 0 \\ 0 & 1\end{matrix} ]$ | $\frac{1}{\sqrt{2}} [ \begin{matrix}1 & 1 \\ 1 & - 1\end{matrix} ]$ | $\frac{1}{\sqrt{2}} [ \begin{matrix}1 & 1 \\ j & - j\end{matrix} ]$ |

Table 3 shows a precoding matrix W for single-layer transmission using four antenna ports with transform precoding enabled.

TABLE 3
Precoding Matrix W for Single-Layer Transmission (Rank 1) Using Four
Antenna Ports (discrete Fourier transform spread orthogonal frequency
division multiplexing)

| | W (Ordered from left to right in increasing order of | | | | | | | |
|---|---|---|---|---|---|---|---|---|
| TPMI Index | TPMI Index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ - 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ - 1\end{matrix} ]$ | $\frac{1}{2} [ \begin{matrix}1 \\ - 1 \\ 1 \\ 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ - 1\end{matrix} ]$ | $\frac{1}{2} [ \begin{matrix}1 \\ - 1 \\ - j \\ j\end{matrix} ]$ |

| | | | | |
|---|---|---|---|---|
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ - 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ 1\end{matrix} ]$ |

Table 4 shows a precoding matrix W for single-layer transmission using four antenna ports with transform precoding disabled.

TABLE 4
Precoding Matrix W for Single-Layer Transmission (Rank 1) Using Four
Antenna Ports (cyclic prefix orthogonal frequency division multiplexing)

| | W (Ordered from left to right in increasing order of | | | | | | | |
|---|---|---|---|---|---|---|---|---|
| TPMI Index | TPMI Index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ - 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ - 1\end{matrix} ]$ | $\frac{1}{2} [ \begin{matrix}1 \\ - 1 \\ 1 \\ 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ - 1\end{matrix} ]$ | $\frac{1}{2} [ \begin{matrix}1 \\ - 1 \\ - j \\ j\end{matrix} ]$ |

| | | | | |
|---|---|---|---|---|
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ - 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ 1\end{matrix} ]$ |

Table 5 shows a precoding matrix W for two-layer transmission using four antenna ports with transform precoding disabled.

TABLE 5
Precoding Matrix W for Two-Layer Transmission (Rank 2) Using Four
Antenna Ports (cyclic prefix orthogonal frequency division multiplexing)

| | W (Ordered from left to right in increasing order of | | | |
|---|---|---|---|---|
| TPMI Index | TPMI Index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}1 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2} [ \begin{matrix}1 & 1 \\ 1 & 1 \\ 1 & - 1 \\ 1 & - 1\end{matrix} ]$ | $\frac{1}{2} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |

| | | |
|---|---|---|
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ |

Table 6 shows a precoding matrix W for three-layer transmission using four antenna ports with transform precoding disabled.

TABLE 6
Precoding Matrix W for Three-Layer Transmission (Rank 3) Using Four Antenna Ports
(cyclic prefix orthogonal frequency division multiplexing)

| | W (Ordered from left to right in increasing order of | | | |
|---|---|---|---|---|
| TPMI Index | TPMI Index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |

| | | | |
|---|---|---|---|
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ |

Table 7 shows a precoding matrix W for four-layer transmission using four antenna ports with transform precoding disabled.

TABLE 7
Precoding Matrix W for Four-Layer Transmission (Rank 4) Using Four
Antenna Ports (cyclic prefix orthogonal frequency division multiplexing):

| TPMI | W (Ordered from left to right in increasing order of | | | |
|---|---|---|---|---|
| Index | TPMI Index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & j & - j\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{2} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |

| | |
|---|---|
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ |

In the DCI scheduling PUSCH (e.g., DCI format 0_1/0_2), TPMI could be indicated via the “Precoding information and number of layers” field, which can indicate the rank and precoder used for PUSCH transmission, i.e., the rank indicator and precoder indicator are jointly encoded.

In 3GPP Rel-18, up to eight layers will be supported for PUSCH transmission. The codebook should be enhanced to support up to eight layers with eight antenna ports.

The codebook design could be based on Rel-15 uplink 2Tx/4Tx precoders. Or the codebook design could be based on Rel-15 downlink Type I codebook.

For Rel-15 DL Type I codebook, it is based on the antenna structure and configuration, such as (N₁, N₂), and (O₁, O₂), where N₁, N₂ are the number of antenna elements in horizontal and vertical direction, respectively, and O₁, O₂ are the oversampling factor in horizontal and vertical direction, respectively. For Type I codebook, the precoder could be constructed according to the rank value and parameter i_{1,1}, i_{1,2}, i_{1,3}, and i₂ reported by the UE.

However, the number of precoders could be large leading to overhead in DCI. The overhead should be addressed in the codebook design.

The TPMIs could be categorized into full coherent TPMI, partial coherent TPMI and non-coherent TPMI, depending on whether relative phase can be maintained among all (full coherent), or a subset (partial coherent), or none (non-coherent) of the antenna ports.

Table 8 shows the non-coherent, partial coherent and full coherent TPMIs 4-ports with rank-1 and rank-2.

TABLE 8
Example of Non-Coherent, Partial Coherent,
and Full Coherent Precoding Matrix

| | | |
|---|---|---|
| 4-port | Non-coherent | Rank-1: TPMI {0~3} as shown in Table 4 |
| | TPMIs | Rank-2: TPMI {0~5} as shown in Table 5 |
| | Partial coherent | Rank-1: TPMI {4~11} as shown in Table 4 |
| | TPMIs | Rank-2: TPMI {6~13} as shown in Table 5 |
| | Full coherent | Rank-1: TPMI {12~27} as shown in Table 4 |
| | TPMIs | Rank-2: TPMI {14~21} as shown in Table 5 |

In Rel-18, the uplink transmission will be extended to eight Tx layers. Therefore, the codebook with eight ports should be defined. For full coherent UE, the codebook could be based on Rel-15 Type I codebook. However, the partial coherent codebook may be used.

In addition, for Rel-18, up to eight layers could be used for uplink transmission, and multiple codewords could be used. The switching between single codeword and multiple codewords should be supported.

The current 3GPP codebook is only for up to four transmission layers and four ports for uplink transmissions, including PUSCH transmissions.

In one or more embodiments, an enhanced method of signaling the TPMI indication may support more than four layers of transmission for PUSCH and other uplink transmissions, and may result in reduced DCI overhead. An enhanced codebook may support up to eight transmission layers and antenna ports, and dynamic switching between a single codeword and multiple codewords.

In one or more embodiments, there may be a joint encoding of the rank indicator and precoder indicator. For example, for PUSCH transmission with 8 Tx, the rank indicator and precoder indicator are jointly encoded in one field(s) in the DCI, i.e., in the TPMI table, the precoders for each rank (depending on the maximum rank configuration) are included. Alternatively, an equation is specified to determine PMI index based on bitfield for RI and CQI or vice-versa, e.g., Equation (1) can be used:

$$I = {\sum }_{r = 1}^{RI - 1} N ( r ) + PMI , \qquad ( Equation 1 )$$

where I is the bitfield value, RI is maximum rank value, N(r)-total number of PMIs for a rank r=1, 2, . . . RI, N(0)=0, PMI—the PMI numbering for rank RI. It could be applied for the codebook based on Rel-15 DL Type I codebook, and the codebook based on Rel-15 UL 2Tx/4Tx precoders.

In one or more embodiments, there may be separate encodings of the rank indicator and for the precoder indicator, such as via the DCI. For example, for PUSCH transmission with 8 ports, separate rank indication and precoder indication could be used in the DCI scheduling PUSCH transmission. It could be applied for the codebook based on Rel-15 DL Type I codebook, and the codebook based on Rel-15 UL 2Tx/4Tx precoders. In the DCI scheduling PUSCH, a new field(s) could be added to indicate the rank used for the PUSCH transmission, i.e., for rank indication. Alternatively, some existing field(s) could be reused/repurposed to indicate the rank. The field length depends on the configured maximum rank. In the DCI scheduling PUSCH, another new field(s) is used to indicate the precoder used for PUSCH transmission (alternatively, some existing field(s) could be reused/repurposed). The field length is determined by: ┌log₂ (max(Nₓ))┐, assuming Nₓ is the number of precoders for rank-x, where x is smaller than or equal to the configured maximum rank.

In another example, if the codebook is based on Rel-15 DL Type I codebook, the precoder indication in DCI could indicate the parameters for the codebook construction, e.g., i_{1,1}, i_{1,2}, i_{1,3}, and i₂ (i_{1,1}, i_{1,2}, i_{1,3}, and i₂ could be indicated via one field or separate fields, the field(s) could be newly added or some existing field(s) could be reused/repurposed). In such case, the field length of the precoder indication is:

$$⌈ {log}_{2} ( max ( {N}_{i 11 , x} ) ) ⌉ + ⌈ {log}_{2} ( max ( {N}_{i 12 , x} ) ) ⌉ + ⌈ {log}_{2} ( max ( {N}_{i 13 , x} ) ) ⌉ + ⌈ {log}_{2} ( max ( {N}_{i 2 , x} ) ) ⌉ ,$$

where:
┌log₂(max(N_{i11,x}))┐: is the length to indicate i_{1,1}, and N_{i11,x} is the number of values of i_{1,1} for rank-x;
┌log₂ (max(N_{i12,x}))┐: is the length to indicate i_{1,2}, and N_{i12,x} is the number of values of i_{1,2} for rank-x;
┌log₂ (max(N_{i13,x}))┐: is the length to indicate i_{1,3}, and N_{i13,x} is the number of values of i_{1,3} for rank-x;
┌log₂ (max(N_{i2,x}))┐: is the length to indicate i₂, and N_{i2,x} is the number of values of i₂ for rank-x.

If the number of values for i_{1,1}/i_{1,2}/i_{1,3}/i₂ is only one, then the corresponding length is zero bits.

For multi-TRP operation, two TPMIs with 8Tx could be indicated. For joint encoding, two fields could be included to indicate two TPMIs with 8Tx. For separate encoding, in order to indicate two TPMIs with 8Tx, two fields could be included for rank indication to indicate two ranks (or one field if the same rank is applied), and two fields could be included for precoder indication to indicate two precoders (or two fields could be included to indicate two set of parameters i_{1,1}, i_{1,2}, i_{1,3}, and i₂).

In one or more embodiments, a codebook subset configuration may be provided. For example, for PUSCH transmission with 8 Tx, the codebook subsets include full coherent codebook subset, partial coherent codebook subset, and non-coherent codebook subset. The full coherent codebook subset could contain full coherent precoders, partial coherent precoders, and non-coherent precoders. The partial coherent codebook subset could contain partial coherent precoders and non-coherent precoders. The non-coherent codebook subset could contain non-coherent precoders.

In one or more embodiments, for PUSCH transmission with 8 Tx, the full coherent codebook subset only contains full coherent precoders. The partial coherent codebook subset only contains partial coherent precoders (or the partial coherent codebook subset contains partial coherent and non-coherent precoders). The non-coherent codebook subset only contains non-coherent precoders.

The codebook subset could be configured by RRC or updated by MAC-CE or DCI. The DCI field configuration for TPMI indication could be determined according to the configured/updated codebook subset.

In one example, the same TPMI indication scheme (whether joint encoding of rank indicator and precoder indicator, or separate rank indication and precoder indication) are used for all the codebook subsets.

In another example, different TPMI indication scheme (whether joint encoding of rank indicator and precoder indicator, or separate rank indication and precoder indication) could be used for different codebook subset. For example, for full coherent codebook subset, separate rank indication and precoder indication is used, and for partial coherent/non-coherent codebook subset, joint encoding of rank indicator and precoder indicator is used.

In another example, if the codebook subset is indicated by DCI, the indication for codebook subset could be based on new fields or some existing fields could be reused/repurposed. ACK should be provided for the DCI indicating codebook subset. And application time should be defined between the receiving of the DCI and the application of indicated codebook subset.

The embodiments for the coodbook subset configuration could be applied for the codebook based on Rel-15 DL Type I codebook, and the codebook based on Rel-15 UL 2Tx/4Tx precoders.

In one or more embodiments, the enhanced codebook may have low overhead based on a DL Type 1 codebook. For example, for PUSCH transmission with 8Tx, if the codebook is based on Rel-15 DL Type I codebook, then RRC or MAC-CE or DCI could be used to configure/update some parameters for the Type I codebook, such as i_{1,1}, i_{1,2}, i_{1,3}, and i₂.

In one example, the parameter i₂ which represents the co-phasing factor could be configured/reconfigured by RRC. Or it could be configured by RRC and updated by MAC-CE. In the DCI scheduling PUSCH, only i_{1,1}/i_{1,2}/i_{1,3} are indicated. The indicated precoder is constructed according to the i_{1,1}/i_{1,2}/i_{1,3} indicated by DCI and i₂ configured/updated by RRC/MAC-CE.

In another example, RRC could configure/reconfigure the values (or subset of the values) of one or several or all the parameters: i_{1,1}, i_{1,2}, i_{1,3}, and i₂ (different values of i_{1,1}/i_{1,2}/i_{1,3}/i₂ could be configured for different rank). Or MAC-CE could be used to configure/select some the values (or subset of the values) of one or several or all the parameters: i_{1,1}, i_{1,2}, i_{1,3}, and i₂ (different values of i_{1,1}/i_{1,2}/i_{1,3}/i₂ could be configured for different rank). In the DCI, the size of the field for TPMI indication is determined according to the subset of the values of i_{1,1}, i_{1,2}, i_{1,3}, and i₂ configured by RRC/MAC-CE (or the DCI field size is pre-defined if the values of i_{1,1}, i_{1,2}, i_{1,3}, and i₂ is configured by MAC-CE).

In one or more embodiments, for PUSCH transmission with 8Tx, if the codebook is based on Rel-15 DL Type I codebook, there could be some restriction to reduce the number of precoders. For example, the value of the oversampling factor (O₁, O₂) could be set to be (2,1) or (1,1). In another example, only a subset of the values for i_{1,1}/i_{1,2}/i_{1,3}/i₂ are used for the codebook generation and precoder indication. In another example, the values (or the subset of the values) for i_{1,1}/i_{1,2}/i_{1,3}/i₂ could be reported by the UE, i.e., subject to UE capability.

In one or more embodiments, for PUSCH transmission with 8Tx, rank restriction could be introduced. The rank restriction could be configured/updated by RRC/MAC-CE. In the DCI, only the precoders for the ranks allowed by the rank restriction can be indicated. And the DCI field size is determined according to the number of precoders for the allowed ranks.

In one or more embodiments, for PUSCH transmission with 8Tx, if the codebook is based on Rel-15 DL Type I codebook, subset of PMI index(es) may be considered for precoder generation and indication.

For index i_{1,1}, parameter D₁ can be configured by the network or specified, where precoding matrix index i_{1,1} is determined based on index

$${i}_{1 , 1}^{′} = \{ 0 , 1 , … , \frac{{N}_{1} {O}_{1}}{{D}_{1}} - 1 \}$$

indicated in the DCI, where i_{1,1}=D₁·i′_{1,1} (e.g. D₁=O₁).

For index i_{1,2}, parameter D₂ can be configured by the network or specified, where precoding matrix index i_{1,2} is determined based on index

$${i}_{1 , 2}^{′} = \{ 0 , 1 , … , \frac{{N}_{2} {O}_{2}}{{D}_{2}} - 1 \}$$

indicated in the DCI, where i_{1,2}=D₂·i′_{1,2} (e.g. D₂=O₂).

For index i_{1,3}, a subset of index values is indicated in DCI or index i_{1,3} is not indicated in the DCI and fixed to 0.

For index i₂, parameter D can be configured by the network or specified, where precoding matrix index i₂ is determined based on index i′₂ indicated in the DCI, where

$${i}_{2} = D \cdot {i}_{2}^{′} , {i}_{2}^{′} = \{ 0 , 1 , … , \frac{4}{D} - 1 \}$$

for rank 1,

$${i}_{2}^{′} = \{ 0 , 1 , … , \frac{2}{D} - 1 \}$$

for rank >1.

In another example, the values of D₁, D₂, and D could be reported by the UE, i.e., subject to UE capability.

In one or more embodiments, for PUSCH transmission with 8Tx, if the codebook is based on Rel-15 DL Type I codebook, the codebook is based on structure W=W₁×W₂. In this case, multiple DCIs could be used for the TPMI indication. For example, one DCI is used to indicate the parameters for W1 (i.e., i_{1,1}, i_{1,2}, i_{1,3}), and the other DCI is used to indicate the parameters for W2 (i.e., i₂). In one option, the DCI for W1 could be transmitted less frequently and the DCI for W2 could be transmitted more frequently. Regarding the DCI for W1, the indication for W1 parameters could be based on new fields or some existing fields could be reused/repurposed. ACK should be provided for the DCI indicating W1. And application time should be defined between the receiving of the DCI and the application of indicated W1. In another option, the DCI for W2 could be transmitted less frequently and the DCI for W1 could be transmitted more frequently. Regarding the DCI for W2, the indication for W2 parameters could be based on new fields or some existing fields could be reused/repurposed. ACK should be provided for the DCI indicating W2. And application time should be defined between the receiving of the DCI and the application of indicated W2.

In one or more embodiments, the TPMI indication for the codebook may be based on Rel-15 UL 2Tx/4Tx precoders. For example, for PUSCH transmission with 8Tx, if the codebook is based on Rel-15 UL 2Tx/4Tx precoders, the codebook could be generated according to Equation (2) or Equation (3):

$${W}_{8 Tx} = {W}_{1 , 2 Tx} ⊗ {W}_{2 , 4 Tx} , \qquad ( Equation 2 )$$

$${W}_{8 Tx} = {W}_{2 , 4 Tx} ⊗ {W}_{1 , 2 Tx} , \qquad ( Equation 3 )$$

wherein W_{1,2Tx} is a Rel-15 UL 2Tx precoder, W_{2,4Tx} is a Rel-15 UL 4Tx precoder, and ⊗ represents Kronecker product operation. For full coherent precoders with 8Tx, both W_{1,2Tx} and W_{2,4Tx} should be full coherent. For partial coherent precoders with 8Tx, W_{1,2Tx} should be non-coherent and W_{2,4Tx} should be full coherent/partial coherent; Or W_{1,2Tx} should be full coherent and W_{2,4Tx} should be non-coherent/partial coherent. For non-coherent precoders with 8Tx, both W_{1,2Tx} and W_{2,4Tx} should be non-coherent. For rank value of {5, 7}, the precoders with 8Tx could be generated by dropping one column of the precoder with rank {6, 8}.

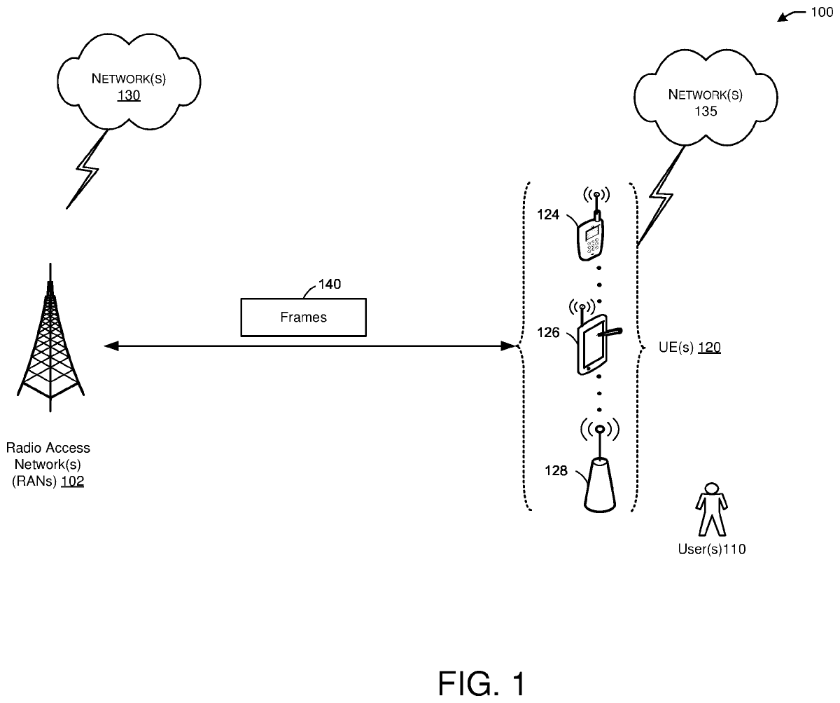

In one example for the precoder generation, W_{1,2Tx} and W_{2,4Tx} could include all the non-coherent/partial-coherent/full coherent precoders for certain rank. For example, W_{1,2Tx} could be TPMI {#2, #3, #4, #5} as shown in FIG. 1. In another option, W_{1,2Tx} and W_{2,4Tx} could include a subset of all the non-coherent/partial-coherent/full coherent precoders for certain rank. For example, W_{1,2Tx} could be just TPMI {#2, #3} as shown in FIG. 1. Alternatively, the supported W_{1,2Tx} and W_{2,4Tx} could be reported by the UE, i.e., subject to UE capability.

For TPMI indication, in the first option, the rank indicator and precoder indicator are jointly encoded in one field(s) in the DCI, i.e., in the TPMI table, the precoders for each rank (depending on the maximum rank configuration) are included.

In the second option for TPMI indication, separate rank indication and precoder indication could be used in the DCI scheduling PUSCH transmission. In the DCI scheduling PUSCH, a new field(s) could be added to indicate the rank used for the PUSCH transmission, i.e., for rank indication. Alternatively, some existing field(s) could be reused/repurposed to indicate the rank. The field length depends on the configured maximum rank. In the DCI scheduling PUSCH, another new field(s) is used to indicate the precoder used for PUSCH transmission (alternatively, some existing field(s) could be reused/repurposed). The field length is determined by: ┌log₂ (max(Nₓ))┐, assuming Nₓ is the number of precoders for rank-x, where x is smaller than or equal to the configured maximum rank.

In the third option for TPMI indication, W_{1,2Tx} and W_{2,4Tx} could be indicated in the DCI scheduling PUSCH. New field(s) could be added to indicate W_{1,2Tx} and W_{2,4Tx} (alternatively, some existing field(s) could be reused/repurposed). When W_{1,2Tx} or W_{2,4Tx} is non-coherent, then it can represent the antenna port group selection.

In the fourth option for TPMI indication, RRC could be used to configure the values (or select a subset) of W_{1,2Tx} and/or W_{2,4Tx}, i.e., the UL 2Tx/4Tx precoders (different W_{1,2Tx} and/or W_{2,4Tx} could be configured for different rank). Alternatively, MAC-CE could be used to configure the values (or select a subset) of W_{1,2Tx} and/or W_{2,4Tx}, i.e., the UL 2Tx/4Tx precoders (different W_{1,2Tx} and/or W_{2,4Tx} could be configured for different rank). It could be applied to the first option to the third option. And the DCI field size in the first option to the third option is determined according to the subset of W_{1,2Tx} and/or W_{2,4Tx} configured by RRC/MAC-CE (or the DCI field size could be pre-defined if W_{1,2Tx} and/or W_{2,4Tx} is configured by MAC-CE). In another example, the values (or the subset of the values) for W_{1,2Tx} and/or W_{2,4Tx} could be reported by the UE, i.e., subject to UE capability.

In the fifth option for TPMI indication, multiple DCIs could be used for the TPMI indication. For example, one DCI is used to indicate W_{1,2Tx}, and the other DCI is used to indicate W_{2,4Tx}. In one example, the DCI for W_{1,2Tx} could be transmitted less frequently and the DCI for W_{2,4Tx} could be transmitted more frequently. Regarding the DCI for W_{1,2Tx}, the indication for W_{1,2Tx} could be based on new fields or some existing fields could be reused/repurposed. ACK should be provided for the DCI indicating W_{1,2Tx}. And application time should be defined between the receiving of the DCI and the application of indicated W_{1,2Tx}. In another example, the DCI for W_{2,4Tx} could be transmitted less frequently and the DCI for W_{1,2Tx} could be transmitted more frequently. Regarding the DCI for W_{2,4Tx}, the indication for W_{2,4Tx} could be based on new fields or some existing fields could be reused/repurposed. ACK should be provided for the DCI indicating W_{2,4Tx}. And application time should be defined between the receiving of the DCI and the application of indicated W_{2,4Tx}.

For multi-TRP operation, two TPMIs with 8Tx could be indicated. For joint encoding (the first option), two fields could be included to indicate two TPMIs with 8Tx. For separate encoding (the second option), in order to indicate two TPMIs with 8Tx, two fields could be included for rank indication to indicate two ranks (or one field if the same rank is applied), and two fields could be included for precoder indication to indicate two precoders. For the third and the fourth option, in order two indicate two TPMIs with 8Tx, two fields could be included for two W_{1,2Tx}, and two fields could be included for two W_{2,4Tx}. This embodiment could be applied to one or multiple or all the following UE coherence: non-coherent, partial coherent, full coherent.

In one or more embodiments, the TPMI indication for the codebook may be based on Rel-15 DL Type I codebook and Rel-15 UL 2Tx/4Tx precoders. For example, for PUSCH transmission with 8Tx, the full coherent precoders could be based on Rel-15 DL Type I codebook, and the non-coherent/partial coherent precoders could be based on Rel-15 UL 2Tx/4Tx precoders.

In the first option, the full coherent codebook subset contains the precoders for all the coherence. In such case, for full coherent codebook subset, joint encoding between rank indictor and precoder indicator, or separate rank indication and precoder indication (as shown in FIG. 8) could be used (or the options in Section D could be used). For partial coherent and non-coherent codebook subset, either option (from the first option to the fifth option) in Section E could be used.

In the second option, the full coherent codebook subset only contains the full coherent precoders. In such case, for full coherent codebook subset, joint encoding between rank indictor and precoder indicator, or separate rank indication and precoder indication (as shown in FIG. 8 or FIG. 9), or the options in Section D could be used. For partial coherent and non-coherent codebook subset, either option (from the first option to the fifth option) could be used.

In one or more embodiments, the uplink codebook with 8 Tx could be based on Rel-15 Type I codebook. For full coherent UE, the precoding matrix for rank-x could be denoted as W_{FC} and is generated according to Rel-15 Type I codebook, where the size of W_{FC} is 8×x. For partial coherent UE, the precoding matrix W_{PC} for rank-x could be generated based on the 8-port full coherent codebook W_{FC}. The partial coherent precoding matrix W_{PC} for rank-x could be generated according to Equation (4).

$${W}_{PC} = B \times {W}_{FC} = [ \begin{matrix}{b}_{1} & 0 & ⋯ & 0 \\ 0 & {b}_{2} & ⋯ & 0 \\ ⋮ & ⋮ & ⋱ & ⋮ \\ 0 & 0 & ⋯ & {b}_{8}\end{matrix} ] \times {W}_{FC} . \qquad ( Equation 4 )$$

The matrix B (the size of B is 8×8) is a diagonal matrix and represents antenna/port selection. The value of the diagonal elements bᵢ (1≤i≤8) could be either zero or non-zero values. For the non-zero values of bᵢ, it means the corresponding antenna port i are co-phasing ports. The number of non-zero values of bᵢ depends on the number of co-phasing ports. For the partial coherent UE with two antenna groups, each group contains four co-phasing antenna ports, the number of non-zero values of bᵢ is four. For the partial coherent UE with four antenna groups, each group contains two co-phasing antenna ports, the number of non-zero values of bᵢ is two.

For example, for the partial coherent UE with two antenna groups, each group contains four co-phasing antenna ports, i.e., antenna port group {#1, #2, #3, #4} and antenna port group {#5, #6, #7, #8}. When generating the partial coherent precoders, either the group of {b₁, b₂, b₃, b₄} or the group of {b₅, b₆, b₇, b₈} could be non-zero value. For example, either {b₁, b₂, b₃, b₄}=1 and {b₅, b₆, b₇, b₈}=0, or {b₁, b₂, b₃, b₄}=0 and {b₅, b₆, b₇, b₈}=1.

One example of the partial coherent precoding matrix for rank-1 is:

$$\frac{1}{2 \sqrt{2}} [ \begin{matrix}1 \\ 1 \\ 1 \\ 1 \\ 0 \\ 0 \\ 0 \\ 0\end{matrix} ] , \frac{1}{2 \sqrt{2}} [ \begin{matrix}0 \\ 0 \\ 0 \\ 0 \\ 1 \\ 1 \\ 1 \\ 1\end{matrix} ] , \frac{1}{2 \sqrt{2}} [ \begin{matrix}1 \\ 1 \\ j \\ j \\ 0 \\ 0 \\ 0 \\ 0\end{matrix} ] , \frac{1}{2 \sqrt{2}} [ \begin{matrix}0 \\ 0 \\ 0 \\ 0 \\ 1 \\ 1 \\ j \\ j\end{matrix} ] ,$$

One example of the partial coherent precoding matrix for rank-2 is:

$$\frac{1}{2 \sqrt{2}} [ \begin{matrix}1 & 1 \\ 1 & 1 \\ 1 & - 1 \\ 1 & - 1 \\ 0 & 0 \\ 0 & 0 \\ 0 & 0 \\ 0 & 0\end{matrix} ] , \frac{1}{2 \sqrt{2}} [ \begin{matrix}0 & 0 \\ 0 & 0 \\ 0 & 0 \\ 0 & 0 \\ 1 & 1 \\ 1 & 1 \\ 1 & - 1 \\ 1 & - 1\end{matrix} ] ,$$

In this manner, for the generated partial coherent precoders, the transmission from multi-layers is always transmitted from the same antenna/port group.

In another embodiment, the partial coherent precoding matrix W_{PC} for rank-x could be expressed by column vector.

$${W}_{PC} = [ \begin{matrix}{W}_{PC , 1} & {W}_{PC , 2} & ⋯ & {W}_{PC , x}\end{matrix} ] \qquad ( Equation 5 )$$

The size of one column vector W_{PC,k} is 8×1, where 1≤k≤x.

The 8-port full coherent codebook W_{FC} for rank-x could also be expressed by column vector.

$${W}_{FC} = [ \begin{matrix}{W}_{FC , 1} & {W}_{FC , 2} & ⋯ & {W}_{FC , x}\end{matrix} ] \qquad ( Equation 6 )$$

The size of one column vector W_{FC,k} is 8×1, where 1≤k≤x.

The column vector of the partial coherent precoding matrix could be generated according to Equation (7).

$${W}_{PC , k} = B \times {W}_{FC , k} = [ \begin{matrix}{b}_{1} & 0 & ⋯ & 0 \\ 0 & {b}_{2} & ⋯ & 0 \\ ⋮ & ⋮ & ⋱ & ⋮ \\ 0 & 0 & ⋯ & {b}_{8}\end{matrix} ] \times {W}_{FC , k} \qquad ( Equation 7 )$$

The matrix B (the size of B is 8×8) is a diagonal matrix and represents antenna/port selection. The value of the diagonal elements bᵢ (1≤i≤8) could be either zero or non-zero values. For the non-zero values of bᵢ, it means the corresponding antenna port i are co-phasing ports.

For different layers, the non-zero values of bᵢ could be over different antenna ports. In this way, for the generated partial coherent precoders, the transmission from different layers could be transmitted over different antenna/port group.

For example, for the partial coherent UE with two antenna groups, each group contains four co-phasing antenna ports, i.e., antenna port group {#1, #3, #5, #7} and antenna port group {#2, #4, #6, #8}. For Rank-2 precoders, for the first layer (k=1), {b₁, b₃, b₅, b₇}=1 and {b₂, b₄, b₆, b₈}=0. For the second layer (k=2), {b₁, b₃, b₅, b₇}=0 and {b₂, b₄, b₆, b₈}=1.

One example of the partial coherent precoding matrix for rank-2 is:

$$\frac{1}{2 \sqrt{2}} [ \begin{matrix}1 & 0 \\ 0 & 1 \\ 1 & 0 \\ 0 & 1 \\ 1 & 0 \\ 0 & - 1 \\ 1 & 0 \\ 0 & - 1\end{matrix} ] ,$$

In another embodiment, the UE should report the UE antenna structure/layout, such as number of antenna/port groups (including in the vertical/horizontal direction), number of antennas/ports per group (including in the vertical/horizontal direction), total number of antennas/ports (including in the vertical/horizontal direction).

In another example, the UE should report the coherence type (full coherence/partial coherence/non-coherence). For partial coherent UE, the UE could also report the coherence port number, for example, port {#1, #3, #5, #7} or port {#1, #2, #3, #4}.

In one or more embodiments, multiple codewords could be used for uplink transmission with 8Tx, e.g., two codewords. And multiple MCS/RV/NDI fields could be configured in the DCI scheduling PUSCH, e.g., two MCS/RV/NDI fields, one for each codeword.

In one example, whether one codeword or multiple codewords are used could be configured by RRC.

In another example, if the maximum number of layers is 4 (the maximum number of layers is configured by RRC maxRank or maxMIMO-Layers), then single codeword is used. If the maximum number of layers is larger than 4, then multiple (e.g., two) codewords are used.

In another example, whether single codeword or multiple codewords are used could depends on the number of layers indicated by DCI. If the number of layers indicated by DCI is larger than 4, then multiple (e.g., two) codewords are used, otherwise single codeword is used.

In another example, a new field could be added to the DCI (or some existing field could be repurposed) to indicate whether single codeword or multiple codewords are used. For example, a new field is added to indicate whether the second codeword is enabled or not. If the second codeword is disabled, then the corresponding MCS/RV/NDI fields for the second codeword should be ignored by the UE.

In another example, multiple maxRank or maxMIMO-Layers values could be configured, one for each codeword. Whether single codeword or multiple codewords is used could be configured/indicated by RRC/DCI.

In another embodiment, the maximum number of codewords, e.g., 1 or 2, could be configured by RRC. If the maximum number of layers of PUSCH configured by RRC is smaller than or equal to 4, then the maximum number of codewords should be 1. If the maximum number of layers of PUSCH configured by RRC is larger than 4, then the maximum number of codewords could be 2.

If different MCS/RV/NDI field are used for two codewords, then the two MCS fields/two RV fields/two NDI fields should be included in the DCI when the maximum number of codewords is configured as 2 by RRC. When the maximum number of codewords is configured as 1 by RRC, only the first MCS field/the first RV field/the first NDI field is included in the DCI.

When the maximum number of codewords is configured as 2 by RRC, in the first option, whether one or two codewords is used for PUSCH could be indicated by the number of layers of PUSCH via the DCI. If the number of layers of PUSCH indicated by the DCI is smaller than or equal to 4, then only one codeword is used, e.g., only the first codeword is used (the second MCS field/the second RV field/the second NDI field could be set to all zeros, or it should be ignored by the UE). If the number of layers of PUSCH indicated by the DCI is larger than 4, then both codewords are used.

When the maximum number of codewords is configured as 2 by RRC, in the second option, whether one or two codewords is used for PUSCH could be indicated by some specific value(s) of one or several fields in the DCI. For example, if the second MCS field and/or the second RV field is set to specific value(s), then it means only the first codeword is used and the second MCS field/the second RV field/the second NDI field should be ignored by the UE.

In another embodiment, if the current active BWP is configured with maximum of one codeword for PUSCH, and BWP switching is triggered to another BWP which is configured with maximum of two codewords for PSUCH, then MCS/RV/NDI field for the second codeword should be zero padded. And the MCS/RC/NDI field for the second codeword should be ignored by the UE for the new BWP.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

FIG. 1 is a network diagram illustrating an example network environment 100, in accordance with one or more example embodiments of the present disclosure.

Wireless network 100 may include one or more UEs 120 and one or more RANs 102 (e.g., gNBs), which may communicate in accordance with 3GPP communication standards. The UE(s) 120 may be mobile devices that are non-stationary (e.g., not having fixed locations) or may be stationary devices.

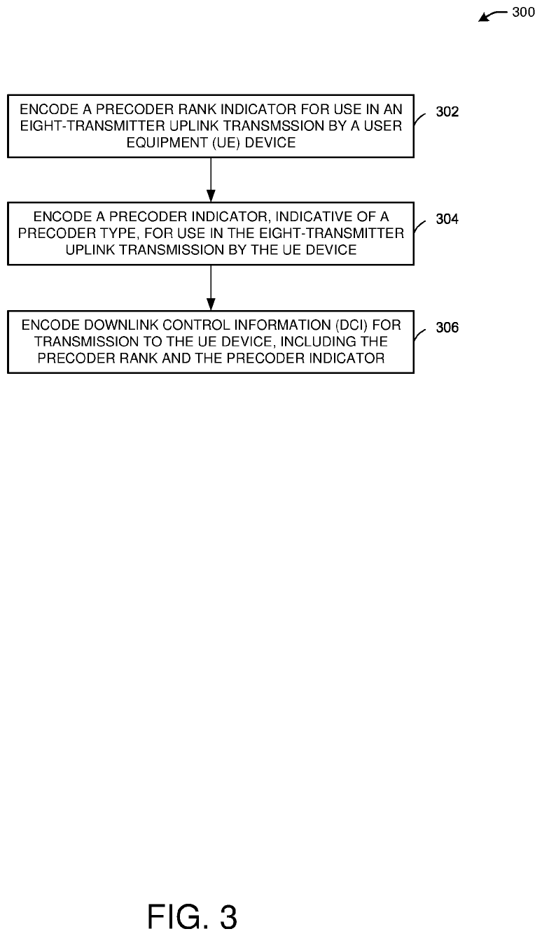

In some embodiments, the UEs 120 and the RANs 102 may include one or more computer systems similar to that of FIGS. 3-5.

One or more illustrative UE(s) 120 and/or RAN(s) 102 may be operable by one or more user(s) 110. A UE may take on multiple distinct characteristics, each of which shape its function. For example, a single addressable unit might simultaneously be a portable UE, a quality-of-service (QOS) UE, a dependent UE, and a hidden UE. The UE(s) 120 (e.g., 124, 126, or 128) and/or RAN(s) 102 may include any suitable processor-driven device including, but not limited to, a mobile device or a non-mobile, e.g., a static device. For example, UE(s) 120 may include, a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

Any of the UE(s) 120 (e.g., UEs 124, 126, 128), and UE(s) 120 may be configured to communicate with each other via one or more communications networks 130 and/or 135 wirelessly or wired. The UE(s) 120 may also communicate peer-to-peer or directly with each other with or without the RAN(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, cellular networks. In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the UE(s) 120 (e.g., UE 124, 126, 128) and RAN(s) 102 may include one or more communications antennas. The one or more communications antennas may be any suitable type of antennas corresponding to the communications protocols used by the UE(s) 120 (e.g., UEs 124, 126 and 128), and RAN(s) 102. Some non-limiting examples of suitable communications antennas include cellular antennas, 3GPP family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the UEs 120 and/or RAN(s) 102.

Any of the UE(s) 120 (e.g., UE 124, 126, 128), and RAN(s) 102 may be configured to perform directional transmission and/or directional reception in conjunction with wirelessly communicating in a wireless network. Any of the UE(s) 120 (e.g., UE 124, 126, 128), and RAN(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the UE(s) 120 (e.g., UE 124, 126, 128), and RAN(s) 102 may be configured to perform any given directional transmission towards one or more defined transmit sectors. Any of the UE(s) 120 (e.g., UE 124, 126, 128), and RAN(s) 102 may be configured to perform any given directional reception from one or more defined receive sectors.

MIMO beamforming in a wireless network may be accomplished using RF beamforming and/or digital beamforming. In some embodiments, in performing a given MIMO transmission, UE 120 and/or RAN(s) 102 may be configured to use all or a subset of its one or more communications antennas to perform MIMO beamforming.

Any of the UE 120 (e.g., UE 124, 126, 128), and RAN(s) 102 may include any suitable radio and/or transceiver for transmitting and/or receiving radio frequency (RF) signals in the bandwidth and/or channels corresponding to the communications protocols utilized by any of the UE(s) 120 and RAN(s) 102 to communicate with each other. The radio components may include hardware and/or software to modulate and/or demodulate communications signals according to pre-established transmission protocols. The radio components may further have hardware and/or software instructions to communicate via one or more 3GPP protocols and using 3GPP bandwidths. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one or more embodiments, and with reference to FIG. 1, one or more of the UEs 120 may exchange frames 140 with the RANs 102. The frames 140 may include UL and DL frames, TMPI signaling, codewords, PUSCH transmissions, DCI transmissions, and the like as described herein.

It is understood that the above descriptions are for purposes of illustration and are not meant to be limiting.

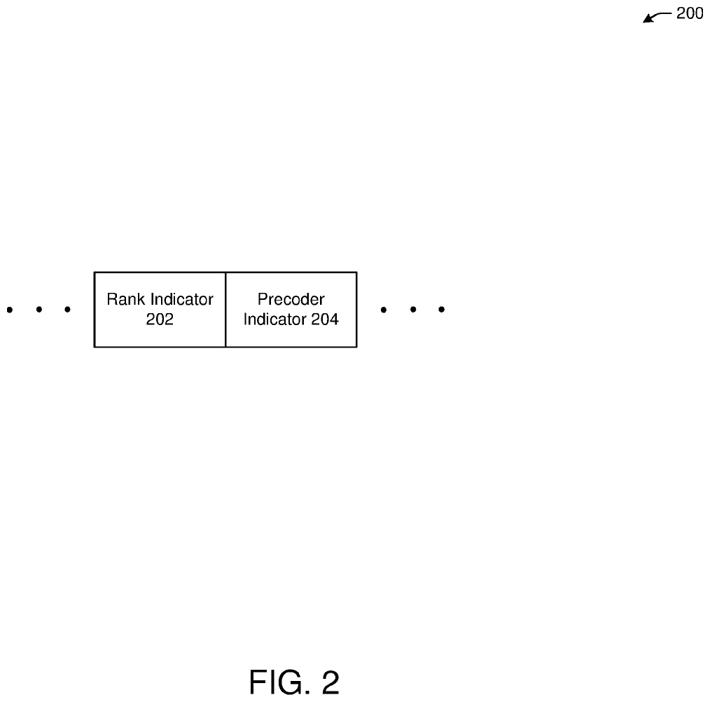

FIG. 2 illustrates an example portion 200 of downlink control information (DCI) signaling used for precoding uplink transmissions, in accordance with one or more example embodiments of the present disclosure.

Referring to FIG. 2, the DCI portion 200 (e.g., for DCI 0_1/0_2) for precoder signaling may include a rank indicator 202 (e.g., to indicate the rank used for an uplink transmission such as PUSCH) and a precoder indicator 204 (e.g., to indicate the precoder used for the uplink transmission).

In an embodiment, for PUSCH transmission with 8 ports, the rank indicator 202 and the precoder indicator 204 may be separate in the DCI scheduling PUSCH transmission. It could be applied for the codebook based on Rel-15 DL Type I codebook, and the codebook based on Rel-15 UL 2Tx/4Tx precoders. The rank indicator 202 may be a new DCI field. Alternatively, some existing field(s) could be reused/repurposed to indicate the rank. The field length depends on the configured maximum rank. In the DCI scheduling PUSCH, the precoder indicator 204 may be new (alternatively, some existing field(s) could be reused/repurposed). The precoder indicator 204 field length is determined by: ┌log₂ (max(Nₓ))┐, assuming Nₓ is the number of precoders for rank-x, where x is smaller than or equal to the configured maximum rank.

In another example, if the codebook is based on Rel-15 DL Type I codebook, the precoder indicator 204 in DCI could indicate the parameters for the codebook construction, e.g., i_{1,1}, i_{1,2}, i_{1,3}, and i₂ (i_{1,1}, i_{1,2}, i_{1,3}, and i₂ could be indicated via one field or separate fields, the field(s) could be newly added or some existing field(s) could be reused/repurposed). In such is: case, the field of length the precoder indication

$$⌈ {log}_{2} ( max ( {N}_{i 11 , x} ) ) ⌉ + ⌈ {log}_{2} ( max ( {N}_{i 12 , x} ) ) ⌉ + ⌈ {log}_{2} ( max ( {N}_{i 13 , x} ) ) ⌉ + ⌈ {log}_{2} ( max ( {N}_{i 2 , x} ) ) ⌉ ,$$

where:
┌log₂ (max(N_{i11,x}))┐: is the length to indicate i_{1,1}, and N_{i11,x} is the number of values of i_{1,1} for rank-x;
log₂ (max(N_{i12,x}))┐: is the length to indicate i_{1,2}, and N_{i12,x} is the number of values of i_{1,2} for rank-x;
┌log₂ (max(N_{i13,x}))┐: is the length to indicate i_{1,3}, and N_{i13,x} is the number of values of i_{1,3} for rank-x;
┌log₂ (max(N_{i2,x}))┐: is the length to indicate i₂, and N_{i2,x} is the number of values of i₂ for rank-x.

If the number of values for i_{1,1}/i_{1,2}/i_{1,3}/i₂ is only one, then the corresponding length of the precoder indicator 204 is zero bits.

For multi-TRP operation, two TPMIs with 8Tx could be indicated. For joint encoding, two fields could be included to indicate two TPMIs with 8Tx. For separate encoding, in order to indicate two TPMIs with 8Tx, two fields could be included for rank indicator 202 to indicate two ranks (or one field if the same rank is applied), and two fields could be included for precoder indicator 204 to indicate two precoders (or two fields could be included to indicate two set of parameters i_{1,1}, i_{1,2}, i_{1,3}, and i₂).

FIG. 3 illustrates a flow diagram of illustrative process 300 for DCI signaling used for precoding uplink transmissions, in accordance with one or more example embodiments of the present disclosure.

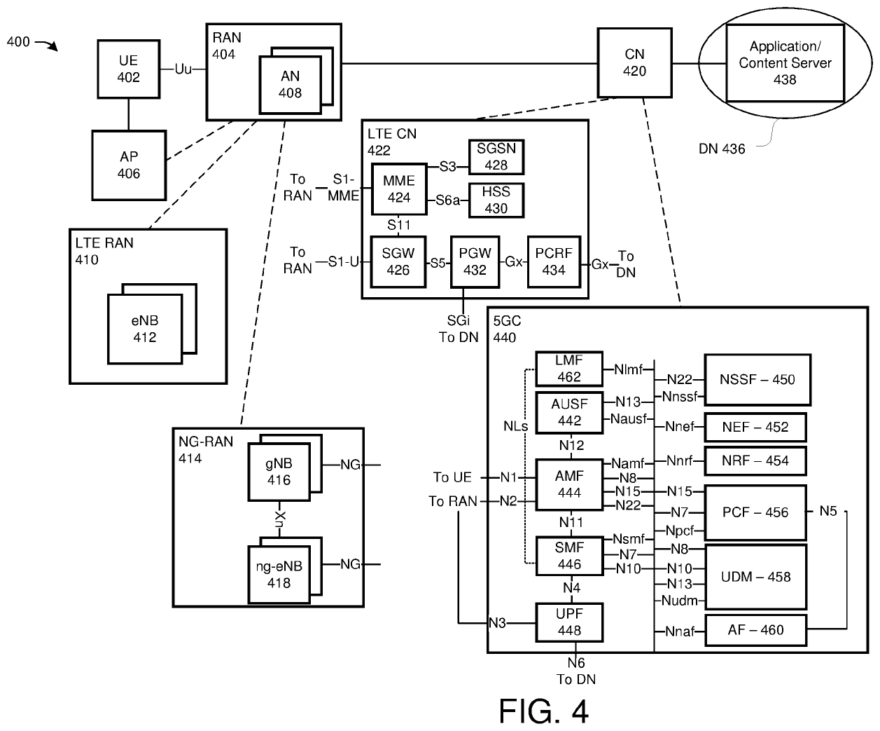

At block 302, a device (e.g., a RANs 102 of FIG. 1, the LTE RAN 410 of FIG. 4, the NG-RAN 414 of FIG. 4) may encode a precoder rank indicator (e.g., the precoder rank indicator 202 of FIG. 2) for use by a UE (e.g., the UE 120 of FIG. 1, the UE 402 of FIG. 4) in an eight-transmitter uplink transmission to the device.

At block 304, the device may encode a precoder indicator (e.g., the precoder indicator 204 of FIG. 2), indicative of a precoder type for use by the UE in the eight-transmitter uplink transmission. The precoder rank indicator and the precoder indicator may be encoded jointly into a same field or separately encoded into different fields.

At block 306, the device may encode downlink control information (DCI) including the precoder rank indicator and the precoder indicator for transmission to the UE to configure the UE for the uplink transmission.

These embodiments are not meant to be limiting.

FIG. 4 illustrates a network 400 in accordance with various embodiments. The network 400 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 400 may include a UE 402, which may include any mobile or non-mobile computing device designed to communicate with a RAN 404 via an over-the-air connection. The UE 402 may be communicatively coupled with the RAN 404 by a Uu interface. The UE 402 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 400 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 402 may additionally communicate with an AP 406 via an over-the-air connection. The AP 406 may manage a WLAN connection, which may serve to offload some/all network traffic from the RAN 404. The connection between the UE 402 and the AP 406 may be consistent with any IEEE 802.11 protocol, wherein the AP 406 could be a wireless fidelity (Wi-Fi®) router. In some embodiments, the UE 402, RAN 404, and AP 406 may utilize cellular-WLAN aggregation (for example, LWA/LWIP). Cellular-WLAN aggregation may involve the UE 402 being configured by the RAN 404 to utilize both cellular radio resources and WLAN resources.

The RAN 404 may include one or more access nodes, for example, AN 408. AN 408 may terminate air-interface protocols for the UE 402 by providing access stratum protocols including RRC, PDCP, RLC, MAC, and L1 protocols. In this manner, the AN 408 may enable data/voice connectivity between CN 420 and the UE 402. In some embodiments, the AN 408 may be implemented in a discrete device or as one or more software entities running on server computers as part of, for example, a virtual network, which may be referred to as a CRAN or virtual baseband unit pool. The AN 408 be referred to as a BS, gNB, RAN node, eNB, ng-eNB, NodeB, RSU, TRxP, TRP, etc. The AN 408 may be a macrocell base station or a low power base station for providing femtocells, picocells or other like cells having smaller coverage areas, smaller user capacity, or higher bandwidth compared to macrocells.

In embodiments in which the RAN 404 includes a plurality of ANs, they may be coupled with one another via an X2 interface (if the RAN 404 is an LTE RAN) or an Xn interface (if the RAN 404 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 404 may each manage one or more cells, cell groups, component carriers, etc. to provide the UE 402 with an air interface for network access. The UE 402 may be simultaneously connected with a plurality of cells provided by the same or different ANs of the RAN 404. For example, the UE 402 and RAN 404 may use carrier aggregation to allow the UE 402 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 404 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 402 or AN 408 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 404 may be an LTE RAN 410 with eNBs, for example, eNB 412. The LTE RAN 410 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 404 may be an NG-RAN 414 with gNBs, for example, gNB 416, or ng-eNBs, for example, ng-eNB 418. The gNB 416 may connect with 5G-enabled UEs using a 5G NR interface. The gNB 416 may connect with a 5G core through an NG interface, which may include an N2 interface or an N3 interface. The ng-eNB 418 may also connect with the 5G core through an NG interface, but may connect with a UE via an LTE air interface. The gNB 416 and the ng-eNB 418 may connect with each other over an Xn interface.

In some embodiments, the NG interface may be split into two parts, an NG user plane (NG-U) interface, which carries traffic data between the nodes of the NG-RAN 414 and a UPF 448 (e.g., N3 interface), and an NG control plane (NG-C) interface, which is a signaling interface between the nodes of the NG-RAN 414 and an AMF 444 (e.g., N2 interface).

The NG-RAN 414 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 402 can be configured with multiple BWPs where each BWP configuration has a different SCS. When a BWP change is indicated to the UE 402, the SCS of the transmission is changed as well. Another use case example of BWP is related to power saving. In particular, multiple BWPs can be configured for the UE 402 with different amount of frequency resources (for example, PRBs) to support data transmission under different traffic loading scenarios. A BWP containing a smaller number of PRBs can be used for data transmission with small traffic load while allowing power saving at the UE 402 and in some cases at the gNB 416. A BWP containing a larger number of PRBs can be used for scenarios with higher traffic load.

The RAN 404 is communicatively coupled to CN 420 that includes network elements to provide various functions to support data and telecommunications services to customers/subscribers (for example, users of UE 402). The components of the CN 420 may be implemented in one physical node or separate physical nodes. In some embodiments, NFV may be utilized to virtualize any or all of the functions provided by the network elements of the CN 420 onto physical compute/storage resources in servers, switches, etc. A logical instantiation of the CN 420 may be referred to as a network slice, and a logical instantiation of a portion of the CN 420 may be referred to as a network sub-slice.

In some embodiments, the CN 420 may be an LTE CN 422, which may also be referred to as an EPC. The LTE CN 422 may include MME 424, SGW 426, SGSN 428, HSS 430, PGW 432, and PCRF 434 coupled with one another over interfaces (or “reference points”) as shown. Functions of the elements of the LTE CN 422 may be briefly introduced as follows.

The MME 424 may implement mobility management functions to track a current location of the UE 402 to facilitate paging, bearer activation/deactivation, handovers, gateway selection, authentication, etc.

The SGW 426 may terminate an S1 interface toward the RAN and route data packets between the RAN and the LTE CN 422. The SGW 426 may be a local mobility anchor point for inter-RAN node handovers and also may provide an anchor for inter-3GPP mobility. Other responsibilities may include lawful intercept, charging, and some policy enforcement.

The SGSN 428 may track a location of the UE 402 and perform security functions and access control. In addition, the SGSN 428 may perform inter-EPC node signaling for mobility between different RAT networks; PDN and S-GW selection as specified by MME 424; MME selection for handovers; etc. The S3 reference point between the MME 424 and the SGSN 428 may enable user and bearer information exchange for inter-3GPP access network mobility in idle/active states.

The HSS 430 may include a database for network users, including subscription-related information to support the network entities' handling of communication sessions. The HSS 430 can provide support for routing/roaming, authentication, authorization, naming/addressing resolution, location dependencies, etc. An S6a reference point between the HSS 430 and the MME 424 may enable transfer of subscription and authentication data for authenticating/authorizing user access to the LTE CN 420.

The PGW 432 may terminate an SGi interface toward a data network (DN) 436 that may include an application/content server 438. The PGW 432 may route data packets between the LTE CN 422 and the data network 436. The PGW 432 may be coupled with the SGW 426 by an S5 reference point to facilitate user plane tunneling and tunnel management. The PGW 432 may further include a node for policy enforcement and charging data collection (for example, PCEF). Additionally, the SGi reference point between the PGW 432 and the data network 436 may be an operator external public, a private PDN, or an intra-operator packet data network, for example, for provision of IMS services. The PGW 432 may be coupled with a PCRF 434 via a Gx reference point.

The PCRF 434 is the policy and charging control element of the LTE CN 422. The PCRF 434 may be communicatively coupled to the app/content server 438 to determine appropriate QoS and charging parameters for service flows. The PCRF 432 may provision associated rules into a PCEF (via Gx reference point) with appropriate TFT and QCI.

In some embodiments, the CN 420 may be a 5GC 440. The 5GC 440 may include an AUSF 442, AMF 444, SMF 446, UPF 448, NSSF 450, NEF 452, NRF 454, PCF 456, UDM 458, and AF 460 coupled with one another over interfaces (or “reference points”) as shown. Functions of the elements of the 5GC 440 may be briefly introduced as follows.

The AUSF 442 may store data for authentication of UE 402 and handle authentication-related functionality. The AUSF 442 may facilitate a common authentication framework for various access types. In addition to communicating with other elements of the 5GC 440 over reference points as shown, the AUSF 442 may exhibit an Nausf service-based interface.

The AMF 444 may allow other functions of the 5GC 440 to communicate with the UE 402 and the RAN 404 and to subscribe to notifications about mobility events with respect to the UE 402. The AMF 444 may be responsible for registration management (for example, for registering UE 402), connection management, reachability management, mobility management, lawful interception of AMF-related events, and access authentication and authorization. The AMF 444 may provide transport for SM messages between the UE 402 and the SMF 446, and act as a transparent proxy for routing SM messages. AMF 444 may also provide transport for SMS messages between UE 402 and an SMSF. AMF 444 may interact with the AUSF 442 and the UE 402 to perform various security anchor and context management functions. Furthermore, AMF 444 may be a termination point of a RAN CP interface, which may include or be an N2 reference point between the RAN 404 and the AMF 444; and the AMF 444 may be a termination point of NAS (N1) signaling, and perform NAS ciphering and integrity protection. AMF 444 may also support NAS signaling with the UE 402 over an N3 IWF interface.

The SMF 446 may be responsible for SM (for example, session establishment, tunnel management between UPF 448 and AN 408); UE IP address allocation and management (including optional authorization); selection and control of UP function; configuring traffic steering at UPF 448 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 444 over N2 to AN 408; and determining SSC mode of a session. SM may refer to management of a PDU session, and a PDU session or “session” may refer to a PDU connectivity service that provides or enables the exchange of PDUs between the UE 402 and the data network 436.

The UPF 448 may act as an anchor point for intra-RAT and inter-RAT mobility, an external PDU session point of interconnect to data network 436, and a branching point to support multi-homed PDU session. The UPF 448 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 448 may include an uplink classifier to support routing traffic flows to a data network.

The NSSF 450 may select a set of network slice instances serving the UE 402. The NSSF 450 may also determine allowed NSSAI and the mapping to the subscribed S-NSSAIs, if needed. The NSSF 450 may also determine the AMF set to be used to serve the UE 402, or a list of candidate AMFs based on a suitable configuration and possibly by querying the NRF 454. The selection of a set of network slice instances for the UE 402 may be triggered by the AMF 444 with which the UE 402 is registered by interacting with the NSSF 550, which may lead to a change of AMF. The NSSF 450 may interact with the AMF 444 via an N22 reference point; and may communicate with another NSSF in a visited network via an N31 reference point (not shown). Additionally, the NSSF 450 may exhibit an Nnssf service-based interface.

The NEF 452 may securely expose services and capabilities provided by 3GPP network functions for third party, internal exposure/re-exposure, AFs (e.g., AF 460), edge computing or fog computing systems, etc. In such embodiments, the NEF 452 may authenticate, authorize, or throttle the AFs. NEF 452 may also translate information exchanged with the AF 460 and information exchanged with internal network functions. For example, the NEF 452 may translate between an AF-Service-Identifier and an internal 5GC information. NEF 452 may also receive information from other NFs based on exposed capabilities of other NFs. This information may be stored at the NEF 452 as structured data, or at a data storage NF using standardized interfaces. The stored information can then be re-exposed by the NEF 452 to other NFs and AFs, or used for other purposes such as analytics. Additionally, the NEF 452 may exhibit an Nnef service-based interface.

The NRF 454 may support service discovery functions, receive NF discovery requests from NF instances, and provide the information of the discovered NF instances to the NF instances. NRF 454 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 454 may exhibit the Nnrf service-based interface.

The PCF 456 may provide policy rules to control plane functions to enforce them, and may also support unified policy framework to govern network behavior. The PCF 456 may also implement a front end to access subscription information relevant for policy decisions in a UDR of the UDM 458. In addition to communicating with functions over reference points as shown, the PCF 456 exhibit an Npcf service-based interface.

The UDM 458 may handle subscription-related information to support the network entities' handling of communication sessions, and may store subscription data of UE 402. For example, subscription data may be communicated via an N8 reference point between the UDM 458 and the AMF 444. The UDM 458 may include two parts, an application front end and a UDR. The UDR may store subscription data and policy data for the UDM 458 and the PCF 456, and/or structured data for exposure and application data (including PFDs for application detection, application request information for multiple UEs 402) for the NEF 452. The Nudr service-based interface may be exhibited by the UDR to allow the UDM 458, PCF 456, and NEF 452 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 458 may exhibit the Nudm service-based interface.

The AF 460 may provide application influence on traffic routing, provide access to NEF, and interact with the policy framework for policy control.

In some embodiments, the 5GC 440 may enable edge computing by selecting operator/3^{rd} party services to be geographically close to a point that the UE 402 is attached to the network. This may reduce latency and load on the network. To provide edge-computing implementations, the 5GC 440 may select a UPF 448 close to the UE 402 and execute traffic steering from the UPF 448 to data network 436 via the N6 interface. This may be based on the UE subscription data, UE location, and information provided by the AF 460. In this way, the AF 460 may influence UPF (re) selection and traffic routing. Based on operator deployment, when AF 460 is considered to be a trusted entity, the network operator may permit AF 460 to interact directly with relevant NFs. Additionally, the AF 460 may exhibit an Naf service-based interface.

The data network 436 may represent various network operator services, Internet access, or third party services that may be provided by one or more servers including, for example, application/content server 438.

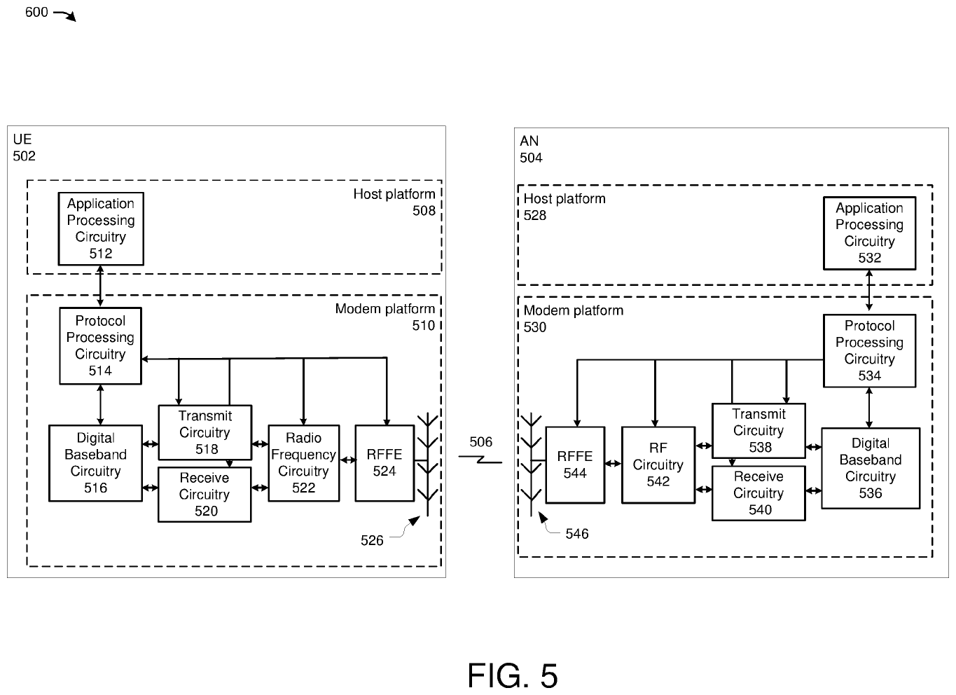

FIG. 5 schematically illustrates a wireless network 500 in accordance with various embodiments. The wireless network 500 may include a UE 502 in wireless communication with an AN 504. The UE 502 and AN 504 may be similar to, and substantially interchangeable with, like-named components described elsewhere herein.

The UE 502 may be communicatively coupled with the AN 504 via connection 506. The connection 506 is illustrated as an air interface to enable communicative coupling, and can be consistent with cellular communications protocols such as an LTE protocol or a 5G NR protocol operating at mmWave or sub-6 GHZ frequencies.

The UE 502 may include a host platform 508 coupled with a modem platform 510. The host platform 508 may include application processing circuitry 512, which may be coupled with protocol processing circuitry 514 of the modem platform 510. The application processing circuitry 512 may run various applications for the UE 502 that source/sink application data. The application processing circuitry 512 may further implement one or more layer operations to transmit/receive application data to/from a data network. These layer operations may include transport (for example UDP) and Internet (for example, IP) operations

The protocol processing circuitry 514 may implement one or more of layer operations to facilitate transmission or reception of data over the connection 506. The layer operations implemented by the protocol processing circuitry 514 may include, for example, MAC, RLC, PDCP, RRC and NAS operations.

The modem platform 510 may further include digital baseband circuitry 516 that may implement one or more layer operations that are “below” layer operations performed by the protocol processing circuitry 514 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 510 may further include transmit circuitry 518, receive circuitry 520, RF circuitry 522, and RF front end (RFFE) 524, which may include or connect to one or more antenna panels 526. Briefly, the transmit circuitry 518 may include a digital-to-analog converter, mixer, intermediate frequency (IF) components, etc.; the receive circuitry 520 may include an analog-to-digital converter, mixer, IF components, etc.; the RF circuitry 522 may include a low-noise amplifier, a power amplifier, power tracking components, etc.; RFFE 524 may include filters (for example, surface/bulk acoustic wave filters), switches, antenna tuners, beamforming components (for example, phase-array antenna components), etc. The selection and arrangement of the components of the transmit circuitry 518, receive circuitry 520, RF circuitry 522, RFFE 524, and antenna panels 526 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 514 may include one or more instances of control circuitry (not shown) to provide control functions for the transmit/receive components.

A UE reception may be established by and via the antenna panels 526, RFFE 524, RF circuitry 522, receive circuitry 520, digital baseband circuitry 516, and protocol processing circuitry 514. In some embodiments, the antenna panels 526 may receive a transmission from the AN 504 by receive-beamforming signals received by a plurality of antennas/antenna elements of the one or more antenna panels 526.

A UE transmission may be established by and via the protocol processing circuitry 514, digital baseband circuitry 516, transmit circuitry 518, RF circuitry 522, RFFE 524, and antenna panels 526. In some embodiments, the transmit components of the UE 504 may apply a spatial filter to the data to be transmitted to form a transmit beam emitted by the antenna elements of the antenna panels 526.

Similar to the UE 502, the AN 504 may include a host platform 528 coupled with a modem platform 530. The host platform 528 may include application processing circuitry 532 coupled with protocol processing circuitry 534 of the modem platform 530. The modem platform may further include digital baseband circuitry 536, transmit circuitry 538, receive circuitry 540, RF circuitry 542, RFFE circuitry 544, and antenna panels 546. The components of the AN 504 may be similar to and substantially interchangeable with like-named components of the UE 502. In addition to performing data transmission/reception as described above, the components of the AN 508 may perform various logical functions that include, for example, RNC functions such as radio bearer management, uplink and downlink dynamic radio resource management, and data packet scheduling.

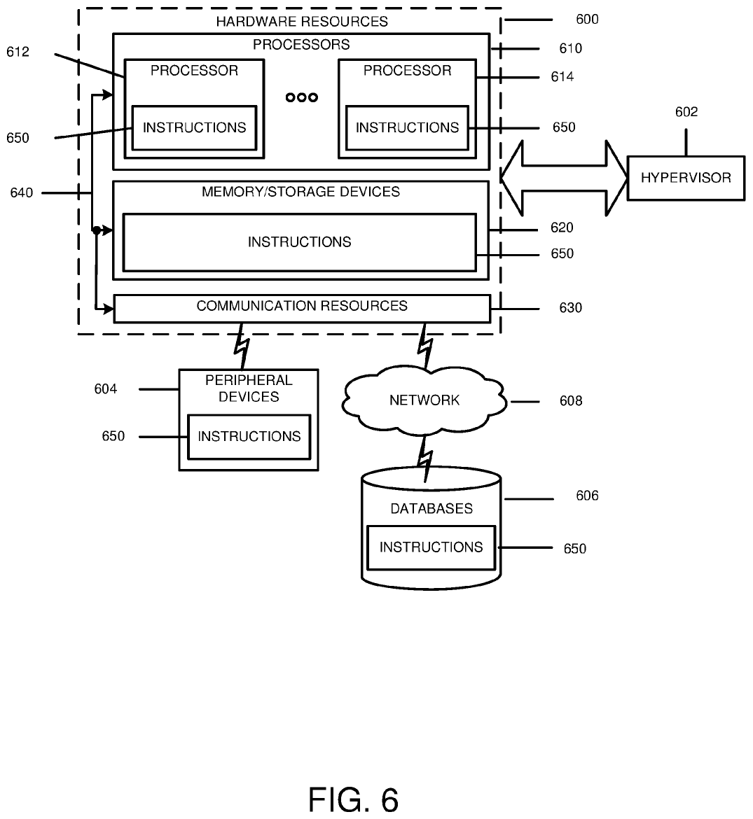

FIG. 6 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 6 shows a diagrammatic representation of hardware resources 600 including one or more processors (or processor cores) 610, one or more memory/storage devices 620, and one or more communication resources 630, each of which may be communicatively coupled via a bus 640 or other interface circuitry. For embodiments where node virtualization (e.g., NFV) is utilized, a hypervisor 602 may be executed to provide an execution environment for one or more network slices/sub-slices to utilize the hardware resources 600.

The processors 610 may include, for example, a processor 612 and a processor 614. The processors 610 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 620 may include main memory, disk storage, or any suitable combination thereof. The memory/storage devices 620 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 630 may include interconnection or network interface controllers, components, or other suitable devices to communicate with one or more peripheral devices 604 or one or more databases 606 or other network elements via a network 608. For example, the communication resources 630 may include wired communication components (e.g., for coupling via USB, Ethernet, etc.), cellular communication components, NFC components, Bluetooth® (or Bluetooth® Low Energy) components, Wi-Fi® components, and other communication components.

Instructions 650 may comprise software, a program, an application, an applet, an app, or other executable code for causing at least any of the processors 610 to perform any one or more of the methodologies discussed herein. The instructions 650 may reside, completely or partially, within at least one of the processors 610 (e.g., within the processor's cache memory), the memory/storage devices 620, or any suitable combination thereof. Furthermore, any portion of the instructions 650 may be transferred to the hardware resources 600 from any combination of the peripheral devices 604 or the databases 606. Accordingly, the memory of processors 610, the memory/storage devices 620, the peripheral devices 604, and the databases 606 are examples of computer-readable and machine-readable media.

The following examples pertain to further embodiments.

Example 1 may include an apparatus of a network device for configuring an uplink transmission for a user equipment device (UE) using eight transmitters, the apparatus comprising processing circuitry coupled to storage for storing information associated with the configuring, the processing circuitry configured to: encode a precoder rank indicator for use in an eight-transmitter uplink transmission by a UE device; encode a precoder indicator, indicative of a precoder type, for use in the eight-transmitter uplink transmission by the UE device; and encode downlink control information (DCI) for transmission to the UE device, the DCI comprising the precoder rank and the precoder indicator. The network device may include a gNB, a base station, or an enodeB, for example.

Example 2 may include the apparatus of example 1 and/or any other example herein, wherein the precoder rank indicator and the precoder indicator are indicative of a fully coherent codebook subset of only fully coherent precoders, a partially coherent codebook subset of only partially coherent precoders, or a non-coherent codebook subset of only non-coherent precoders.

Example 3 may include the apparatus of example 1 and/or any other example herein, wherein the precoder rank indicator and the precoder indicator are indicative of two codewords to be used by the UE device in the uplink transmission, and wherein the uplink transmission is a physical uplink shared control channel (PUSCH) transmission.

Example 4 may include the apparatus of example 1 and/or any other example herein, wherein the precoder rank indicator and the precoder indicator are jointly encoded in one field of the DCI.

Example 5 may include the apparatus of example 1 and/or any other example herein, wherein the precoder rank indicator and the precoder indicator are jointly encoded in one field of the DCI and are indicative of precoder matrix index.

Example 6 may include the apparatus of example 1 and/or any other example herein, wherein the precoder rank indicator and the precoder indicator are separately encoded into two different fields of the DCI.

Example 7 may include the apparatus of example 1 and/or any other example herein, wherein the precoder indicator is indicative of parameters for codebook construction.

Example 8 may include the apparatus of example 1 and/or any other example herein, wherein the precoder rank indicator and the precoder indicator are indicative of a fully coherent codebook subset comprising fully coherent precoders, partially coherent precoders, and non-coherent precoders, further indicative of a partially coherent codebook subset comprising partially coherent precoders and non-coherent precoders, and further indicative of a non-coherent codebook subset of only non-coherent precoders.

Example 9 may include the apparatus of example 1 and/or any other example herein, wherein the processing circuitry is further configured to: encode radio resource control (RRC) information for transmission to the UE device, the RRC information comprising an indication of a codebook subset for use by the UE device in the uplink transmission.

Example 10 may include the apparatus of example 1 and/or any other example herein, wherein the processing circuitry is further configured to: encode a medium access control (MAC) control element (MAC-CE) for transmission to the UE device, the MAC-CE indicative of codebook parameters for use by the UE device in the uplink transmission.

Example 11 may include the apparatus of example 1 and/or any other example herein, wherein the processing circuitry is further configured to: encode a second DCI for transmission to the UE device, wherein the DCI is indicative of a first precoder matrix for use by the UE device in the uplink transmission, and wherein the second DCI is indicative of a second precoder matrix for use by the UE device in the uplink transmission.

Example 12 may include the apparatus of example 1 and/or any other example herein, wherein a size of a precoder matrix indicated by the DCI is eight multiplied by a rank indicated by the precoder rank indicator.

Example 13 may include the apparatus of example 1 and/or any other example herein, wherein a partial precoding matrix for use by the UE in the uplink transmission may be based on a rank indicated by the precoder rank indicator, and an 8×8 diagonal matrix multiplied by a partial precoding matrix, wherein the 8×8 diagonal matrix represents an antenna selection for the uplink transmission.

Example 14 may include the apparatus of example 1 and/or any other example herein, wherein the processing circuitry is further configured to: decode an antenna structure of the UE, received from the UE, indicative of a number of antenna groups, a number of antennas per antenna group, and a total number of antennas of the UE.

Example 15 may include the apparatus of example 1 and/or any other example herein, wherein the processing circuitry is further configured to: decode an indication of full coherence, partial coherence, or non-coherence, received from the UE device.

Example 16 may include the apparatus of example 1 and/or any other example herein, wherein the DCI indicates that a first codeword in the uplink transmission by the UE is to be based on a first maximum rank or first maximum multiple input multiple output layers, and that a second codeword in the uplink transmission by the UE is to be based on a second maximum rank or second maximum multiple input multiple output layers.

Example 17 may include a computer-readable storage medium comprising instructions to cause processing circuitry of a network device for configuring an uplink transmission for a user equipment device (UE) using eight transmitters, upon execution of the instructions by the processing circuitry, to: encode a precoder rank indicator for use in an eight-transmitter uplink transmission by a UE device; encode a precoder indicator, indicative of a precoder type, for use in the eight-transmitter uplink transmission by the UE device; and encode downlink control information (DCI) for transmission to the UE device, the DCI comprising the precoder rank and the precoder indicator.

Example 19 may include a method for configuring an uplink transmission for a user equipment device (UE) using eight transmitters, the method comprising: encoding, by processing circuitry of a network device, a precoder rank indicator for use in an eight-transmitter uplink transmission by a UE device; encoding, by the processing circuitry, a precoder indicator, indicative of a precoder type, for use in the eight-transmitter uplink transmission by the UE device; and encoding, by the processing circuitry, downlink control information (DCI) for transmission to the UE device, the DCI comprising the precoder rank and the precoder indicator.

Example 20 may include an apparatus comprising means for: encoding, by a network device, a precoder rank indicator for use in an eight-transmitter uplink transmission by a UE device; encoding a precoder indicator, indicative of a precoder type, for use in the eight-transmitter uplink transmission by the UE device; and encoding downlink control information (DCI) for transmission to the UE device, the DCI comprising the precoder rank and the precoder indicator.

Example 21 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 22 may include an apparatus comprising logic, modules, and/or circuitry to perform one or more elements of a method described in or related to any of examples 1-20, or any other method or process described herein.

Example 23 may include a method, technique, or process as described in or related to any of examples 1-20, or portions or parts thereof.

Example 24 may include an apparatus comprising: one or more processors and one or more computer readable media comprising instructions that, when executed by the one or more processors, cause the one or more processors to perform the method, techniques, or process as described in or related to any of examples 1-20, or portions thereof.

Example 25 may include a method of communicating in a wireless network as shown and described herein.

Example 26 may include a system for providing wireless communication as shown and described herein.

Example 27 may include a device for providing wireless communication as shown and described herein.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Various embodiments are described below.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

Unless used differently herein, terms, definitions, and abbreviations may be consistent with terms, definitions, and abbreviations defined in 3GPP TR 21.905 v16.0.0 (2019-06) and/or any other 3GPP standard. For the purposes of the present document, the following abbreviations (shown in Table 9) may apply to the examples and embodiments discussed herein.

TABLE 9
Abbreviations

3GPP Third Generation Partnership Project
4G Fourth Generation
5G Fifth Generation
5GC 5G Core network
AC Application Client
ACK Acknowledgement
ACID Application Client Identification
AF Application Function
AM Acknowledged Mode
AMBR Aggregate Maximum Bit Rate
AMF Access and Mobility Management Function
AN Access Network
ANR Automatic Neighbour Relation
AP Application Protocol, Antenna Port, Access Point
API Application Programming Interface
APN Access Point Name
ARP Allocation and Retention Priority
ARQ Automatic Repeat Request
AS Access Stratum
ASP Application Service Provider
ASN.1 Abstract Syntax Notation One
AUSF Authentication Server Function
AWGN Additive White Gaussian Noise
BAP Backhaul Adaptation Protocol
BCH Broadcast Channel
BER Bit Error Ratio
BFD Beam Failure Detection
BLER Block Error Rate
BPSK Binary Phase Shift Keying
BRAS Broadband Remote Access Server
BSS Business Support System
BS Base Station
BSR Buffer Status Report
BW Bandwidth
BWP Bandwidth Part
C-RNTI Cell Radio Network Temporary Identity
CA Carrier Aggregation, Certification Authority
CAPEX CAPital EXpenditure
CBRA Contention Based Random Access
CC Component Carrier, Country Code, Cryptographic Checksum
CCA Clear Channel Assessment
CCE Control Channel Element
CCCH Common Control Channel
CE Coverage Enhancement
CDM Content Delivery Network
CDMA Code-Division Multiple Access
CFRA Contention Free Random Access
CG Cell Group
CGF Charging Gateway Function
CHF Charging Function
CI Cell Identity
CID Cell-ID (e.g., positioning method)
CIM Common Information Model
CIR Carrier to Interference Ratio
CK Cipher Key
CM Connection Management, Conditional Mandatory
CMAS Commercial Mobile Alert Service
CMD Command
CMS Cloud Management System
CO Conditional Optional
CoMP Coordinated Multi-Point
CORESET Control Resource Set
COTS Commercial Off-The-Shelf
CP Control Plane, Cyclic Prefix, Connection Point
CPD Connection Point Descriptor
CPE Customer Premise Equipment
CPICH Common Pilot Channel
CQI Channel Quality Indicator
CPU CSI processing unit, Central Processing Unit
C/R Command/Response field bit
CRAN Cloud Radio Access Network, Cloud RAN
CRB Common Resource Block
CRC Cyclic Redundancy Check
CRI Channel-State Information Resource Indicator,
CSI-RS Resource Indicator
C-RNTI Cell RNTI
CS Circuit Switched
CSAR Cloud Service Archive
CSI Channel-State Information
CSI-IM CSI Interference Measurement
CSI-RS CSI Reference Signal
CSI-RSRP CSI reference signal received power
CSI-RSRQ CSI reference signal received quality
CSI-SINR CSI signal-to-noise and interference ratio
CSMA Carrier Sense Multiple Access
CSMA/CA CSMA with collision avoidance
CSS Common Search Space, Cell-specific Search Space
CTF Charging Trigger Function
CTS Clear-to-Send
CW Codeword
CWS Contention Window Size
D2D Device-to-Device
DC Dual Connectivity, Direct Current
DCI Downlink Control Information
DF Deployment Flavour
DL Downlink
DMTF Distributed Management Task Force
DPDK Data Plane Development Kit
DM-RS, DMRS Demodulation Reference Signal
DN Data network
DNN Data Network Name
DNAI Data Network Access Identifier
DRB Data Radio Bearer
DRS Discovery Reference Signal
DRX Discontinuous Reception
DSL Domain Specific Language. Digital Subscriber Line
DSLAM DSL Access Multiplexer
DwPTS Downlink Pilot Time Slot
E-LAN Ethernet Local Area Network
E2E End-to-End
ECCA extended clear channel assessment, extended CCA
ECCE Enhanced Control Channel Element, Enhanced CCE
ED Energy Detection
EDGE Enhanced Datarates for GSM Evolution (GSM Evolution)
EAS Edge Application Server
EASID Edge Application Server Identification
ECS Edge Configuration Server
ECSP Edge Computing Service Provider
EDN Edge Data Network
EEC Edge Enabler Client
EECID Edge Enabler Client Identification
EES Edge Enabler Server
EESID Edge Enabler Server Identification
EHE Edge Hosting Environment
EGMF Exposure Governance tableManagement Function
EGPRS Enhanced GPRS
EIR Equipment Identity Register
eLAA enhanced Licensed Assisted Access, enhanced LAA
EM Element Manager
eMBB Enhanced Mobile Broadband
EMS Element Management System
eNB evolved NodeB, E-UTRAN Node B
EN-DC E-UTRA-NR Dual Connectivity
EPC Evolved Packet Core
EPDCCH enhanced PDCCH, enhanced Physical Downlink Control Cannel
EPRE Energy per resource element
EPS Evolved Packet System
EREG enhanced REG, enhanced resource element groups
ETSI European Telecommunications Standards Institute
ETWS Earthquake and Tsunami Warning System
eUICC embedded UICC, embedded Universal Integrated Circuit Card
E-UTRA Evolved UTRA
E-UTRAN Evolved UTRAN
EV2X Enhanced V2X
F1AP F1 Application Protocol
F1-C F1 Control plane interface
F1-U F1 User plane interface
FACCH Fast Associated Control CHannel
FACCH/F Fast Associated Control Channel/Full rate
FACCH/H Fast Associated Control Channel/Half rate
FACH Forward Access Channel
FAUSCH Fast Uplink Signalling Channel
FB Functional Block
FBI Feedback Information
FCC Federal Communications Commission
FCCH Frequency Correction CHannel
FDD Frequency Division Duplex
FDM Frequency Division Multiplex
FDMA Frequency Division Multiple Access
FE Front End
FEC Forward Error Correction
FFS For Further Study
FFT Fast Fourier Transformation
feLAA further enhanced Licensed Assisted Access, further enhanced LAA
FN Frame Number
FPGA Field-Programmable Gate Array
FR Frequency Range
FQDN Fully Qualified Domain Name
G-RNTI GERAN Radio Network Temporary Identity
GERAN GSM EDGE RAN, GSM EDGE Radio Access Network
GGSN Gateway GPRS Support Node
GLONASS GLObal’naya NAvigatsionnaya Sputnikovaya Sistema
(Engl.: Global Navigation Satellite System)
gNB Next Generation NodeB
gNB-CUgNB-centralized unit, Next Generation NodeB centralized unit
gNB-DUgNB-distributed unit, Next Generation NodeB distributed unit
GNSS Global Navigation Satellite System
GPRS General Packet Radio Service
GPSI Generic Public Subscription Identifier
GSM Global System for Mobile Communications, Groupe Spécial Mobile
GTP GPRS Tunneling Protocol
GTP-U GPRS Tunnelling Protocol for User Plane
GTS Go To Sleep Signal (related to WUS)
GUMMEI Globally Unique MME Identifier
GUTI Globally Unique Temporary UE Identity
HARQ Hybrid ARQ, Hybrid Automatic Repeat Request
HANDO Handover
HFN HyperFrame Number
HHO Hard Handover
HLR Home Location Register
HN Home Network
HO Handover
HPLMN Home Public Land Mobile Network
HSDPA High Speed Downlink Packet Access
HSN Hopping Sequence Number
HSPA High Speed Packet Access
HSS Home Subscriber Server
HSUPA High Speed Uplink Packet Access
HTTP Hyper Text Transfer Protocol
HTTPS Hyper Text Transfer Protocol Secure
(https is http/1.1 over SSL, i.e. port 443)
I-Block Information Block
ICCID Integrated Circuit Card Identification
IAB Integrated Access and Backhaul
ICIC Inter-Cell Interference Coordination
ID Identity, identifier
IDFT Inverse Discrete Fourier Transform
IE Information element
IBE In-Band Emission
IEEE Institute of Electrical and Electronics Engineers
IEI Information Element Identifier
IEIDL Information Element Identifier Data Length
IETF Internet Engineering Task Force
IF Infrastructure
IM Interference Measurement, Intermodulation, IP Multimedia
IMC IMS Credentials
IMEI International Mobile Equipment Identity
IMGI International mobile group identity
IMPI IP Multimedia Private Identity
IMPU IP Multimedia PUblic identity
IMS IP Multimedia Subsystem
IMSI International Mobile Subscriber Identity
IoT Internet of Things
IP Internet Protocol
Ipsec IP Security, Internet Protocol Security
IP-CAN IP-Connectivity Access Network
IP-M IP Multicast
IPv4 Internet Protocol Version 4
IPv6 Internet Protocol Version 6
IR Infrared
IS In Sync
IRP Integration Reference Point
ISDN Integrated Services Digital Network
ISIM IM Services Identity Module
ISO International Organisation for Standardisation
ISP Internet Service Provider
IWF Interworking-Function
I-WLAN Interworking WLAN
Constraint length of the convolutional code, USIM Individual key
kB Kilobyte (1000 bytes)
kbps kilo-bits per second
Kc Ciphering key
Ki Individual subscriber authentication key
KPI Key Performance Indicator
KQI Key Quality Indicator
KSI Key Set Identifier
ksps kilo-symbols per second
KVM Kernel Virtual Machine
L1 Layer 1 (physical layer)
L1-RSRP Layer 1 reference signal received power
L2 Layer 2 (data link layer)
L3 Layer 3 (network layer)
LAA Licensed Assisted Access
LAN Local Area Network
LADN Local Area Data Network
LBT Listen Before Talk
LCM LifeCycle Management
LCR Low Chip Rate
LCS Location Services
LCID Logical Channel ID
LI Layer Indicator
LLC Logical Link Control, Low Layer Compatibility
LPLMN Local PLMN
LPP LTE Positioning Protocol
LSB Least Significant Bit
LTE Long Term Evolution
LWA LTE-WLAN aggregation
LWIP LTE/WLAN Radio Level Integration with IPsec Tunnel
LTE Long Term Evolution
M2M Machine-to-Machine
MAC Medium Access Control (protocol layering context)
MAC Message authentication code (security/encryption context)
MAC-A MAC used for authentication and key agreement
(TSG T WG3 context)
MAC-I MAC used for data integrity of signalling messages
(TSG T WG3 context)
MANO Management and Orchestration
MBMS Multimedia Broadcast and Multicast Service
MBSFN Multimedia Broadcast multicast service
Single Frequency Network
MCC Mobile Country Code
MCG Master Cell Group
MCOT Maximum Channel Occupancy Time
MCS Modulation and coding scheme
MDAF Management Data Analytics Function
MDAS Management Data Analytics Service
MDT Minimization of Drive Tests
ME Mobile Equipment
MeNB master eNB
MER Message Error Ratio
MGL Measurement Gap Length
MGRP Measurement Gap Repetition Period
MIB Master Information Block, Management Information Base
MIMO Multiple Input Multiple Output
MLC Mobile Location Centre
MM Mobility Management
MME Mobility Management Entity
MN Master Node
MNO Mobile Network Operator
MO Measurement Object, Mobile Originated
MPBCH MTC Physical Broadcast CHannel
MPDCCH MTC Physical Downlink Control CHannel
MPDSCH MTC Physical Downlink Shared CHannel
MPRACH MTC Physical Random Access CHannel
MPUSCH MTC Physical Uplink Shared Channel
MPLS MultiProtocol Label Switching
MS Mobile Station
MSB Most Significant Bit
MSC Mobile Switching Centre
MSI Minimum System Information,
MCH Scheduling Information
MSID Mobile Station Identifier
MSIN Mobile Station Identification Number
MSISDN Mobile Subscriber ISDN Number
MT Mobile Terminated, Mobile Termination
MTC Machine-Type Communications
mMTC massive MTC, massive Machine-Type Communications
MU-MIMO Multi User MIMO
MWUS MTC wake-up signal, MTC WUS
NACK Negative Acknowledgement
NAI Network Access Identifier
NAS Non-Access Stratum, Non-Access Stratum layer
NCT Network Connectivity Topology
NC-JT Non-Coherent Joint Transmission
NEC Network Capability Exposure
NE-DC NR-E-UTRA Dual Connectivity
NEF Network Exposure Function
NF Network Function
NFP Network Forwarding Path
NFPD Network Forwarding Path Descriptor
NFV Network Functions Virtualization
NFVI NFV Infrastructure
NFVO NFV Orchestrator
NG Next Generation, Next Gen
NGEN-DC NG-RAN E-UTRA-NR Dual Connectivity
NM Network Manager
NMS Network Management System
N-PoP Network Point of Presence
NMIB, N-MIB Narrowband MIB
NPBCH Narrowband Physical Broadcast CHannel
NPDCCH Narrowband Physical Downlink Control CHannel
NPDSCH Narrowband Physical Downlink Shared CHannel
NPRACH Narrowband Physical Random Access CHannel
NPUSCH Narrowband Physical Uplink Shared CHannel
NPSS Narrowband Primary Synchronization Signal
NSSS Narrowband Secondary Synchronization Signal
NR New Radio, Neighbour Relation
NRF NF Repository Function
NRS Narrowband Reference Signal
NS Network Service
NSA Non-Standalone operation mode
NSD Network Service Descriptor
NSR Network Service Record
NSSAI Network Slice Selection Assistance Information
S-NNSAI Single-NSSAI
NSSF Network Slice Selection Function
NW Network
NWUS Narrowband wake-up signal, Narrowband WUS
NZP Non-Zero Power
O&M Operation and Maintenance
ODU2 Optical channel Data Unit - type 2
OFDM Orthogonal Frequency Division Multiplexing
OFDMA Orthogonal Frequency Division Multiple Access
OOB Out-of-Band
OOS Out of Sync
OPEX OPerating EXpense
OSI Other System Information
OSS Operations Support System
OTA over-the-air
PAPR Peak-to-Average Power Ratio
PAR Peak to Average Ratio
PBCH Physical Broadcast Channel
PC Power Control, Personal Computer
PCC Primary Component Carrier, Primary CC
PCell Primary Cell
PCI Physical Cell ID, Physical Cell Identity
PCEF Policy and Charging Enforcement Function
PCF Policy Control Function
PCRFPolicy Control and Charging Rules Function
PDCP Packet Data Convergence Protocol,
Packet Data Convergence Protocol layer
PDCCH Physical Downlink Control Channel
PDCP Packet Data Convergence Protocol
PDN Packet Data Network, Public Data Network
PDSCH Physical Downlink Shared Channel
PDU Protocol Data Unit
PEI Permanent Equipment Identifiers
PFD Packet Flow Description
P-GW PDN Gateway
PHICH Physical hybrid-ARQ indicator channel
PHY Physical layer
PLMN Public Land Mobile Network
PIN Personal Identification Number
PM Performance Measurement
PMI Precoding Matrix Indicator
PNF Physical Network Function
PNFD Physical Network Function Descriptor
PNFR Physical Network Function Record
POC PTT over Cellular
PP, PTP Point-to-Point
PPP Point-to-Point Protocol
PRACH Physical RACH
PRB Physical resource block
PRG Physical resource block group
ProSe Proximity Services, Proximity-Based Service
PRS Positioning Reference Signal
PRR Packet Reception Radio
PS Packet Services
PSBCH Physical Sidelink Broadcast Channel
PSDCH Physical Sidelink Downlink Channel
PSCCH Physical Sidelink Control Channel
PSSCH Physical Sidelink Shared Channel
PSCell Primary SCell
PSS Primary Synchronization Signal
PSTN Public Switched Telephone Network
PT-RS Phase-tracking reference signal
PTT Push-to-Talk
PUCCH Physical Uplink Control Channel
PUSCH Physical Uplink Shared Channel
QAM Quadrature Amplitude Modulation
QCI QoS class of identifier
QCL Quasi co-location
QFI QoS Flow ID, QoS Flow Identifier
QoS Quality of Service
QPSK Quadrature (Quarternary) Phase Shift Keying
QZSS Quasi-Zenith Satellite System
RA-RNTI Random Access RNTI
RAB Radio Access Bearer, Random Access Burst
RACH Random Access Channel
RADIUS Remote Authentication Dial In User Service
RAN Radio Access Network
RAND RANDom number (used for authentication)
RAR Random Access Response
RAT Radio Access Technology
RAU Routing Area Update
RB Resource block, Radio Bearer
RBG Resource block group
REG Resource Element Group
Rel Release
REQ REQuest
RF Radio Frequency
RI Rank Indicator
RIV Resource indicator value
RL Radio Link
RLC Radio Link Control, Radio Link Control layer
RLC AM RLC Acknowledged Mode
RLC UM RLC Unacknowledged Mode
RLF Radio Link Failure
RLM Radio Link Monitoring
RLM-RS Reference Signal for RLM
RM Registration Management
RMC Reference Measurement Channel
RMSI Remaining MSI, Remaining Minimum System Information
RN Relay Node
RNC Radio Network Controller
RNL Radio Network Layer
RNTI Radio Network Temporary Identifier
ROHC RObust Header Compression
RRC Radio Resource Control, Radio Resource Control layer
RRM Radio Resource Management
RS Reference Signal
RSRP Reference Signal Received Power
RSRQ Reference Signal Received Quality
RSSI Received Signal Strength Indicator
RSU Road Side Unit
RSTD Reference Signal Time difference
RTP Real Time Protocol
RTS Ready-To-Send
RTT Round Trip Time
Rx Reception, Receiving, Receiver
S1AP S1 Application Protocol
S1-MMES1 for the control plane
S1-U S1 for the user plane
S-GW Serving Gateway
S-RNTI SRNC Radio Network Temporary Identity
S-TMSI SAE Temporary Mobile Station Identifier
SA Standalone operation mode
SAE System Architecture Evolution
SAP Service Access Point
SAPD Service Access Point Descriptor
SAPI Service Access Point Identifier
SCC Secondary Component Carrier, Secondary CC
SCell Secondary Cell
SCEF Service Capability Exposure Function
SC-FDMA Single Carrier Frequency Division Multiple Access
SCG Secondary Cell Group
SCM Security Context Management
SCS Subcarrier Spacing
SCTP Stream Control Transmission Protocol
SDAP Service Data Adaptation Protocol,
Service Data Adaptation Protocol layer
SDL Supplementary Downlink
SDNF Structured Data Storage Network Function
SDP Session Description Protocol
SDSF Structured Data Storage Function
SDU Service Data Unit
SEAF Security Anchor Function
SeNB secondary eNB
SEPP Security Edge Protection Proxy
SFI Slot format indication
SFTD Space-Frequency Time Diversity, SFN and frame timing difference
SFN System Frame Number
SgNB Secondary gNB
SGSN Serving GPRS Support Node
S-GW Serving Gateway
SI System Information
SI-RNTI System Information RNTI
SIB System Information Block
SIM Subscriber Identity Module
SIP Session Initiated Protocol
SiP System in Package
SL Sidelink
SLA Service Level Agreement
SM Session Management
SMF Session Management Function
SMS Short Message Service
SMSF SMS Function
SMTC SSB-based Measurement Timing Configuration
SN Secondary Node, Sequence Number
SoC System on Chip
SON Self-Organizing Network
SpCell Special Cell
SP-CSI-RNTI Semi-Persistent CSI RNTI
SPS Semi-Persistent Scheduling
SQN Sequence number
SR Scheduling Request
SRB Signalling Radio Bearer
SRS Sounding Reference Signal
SS Synchronization Signal
SSB Synchronization Signal Block
SSID Service Set Identifier
SS/PBCH Block
SSBRI SS/PBCH Block Resource Indicator,
Synchronization Signal Block Resource Indicator
SSC Session and Service Continuity
SS-RSRP Synchronization Signal based Reference Signal
Received Power
SS-RSRQ Synchronization Signal based Reference Signal
Received Quality
SS-SINR Synchronization Signal based Signal to Noise
and Interference Ratio
SSS Secondary Synchronization Signal
SSSG Search Space Set Group
SSSIF Search Space Set Indicator
SST Slice/Service Types
SU-MIMO Single User MIMO
SUL Supplementary Uplink
TA Timing Advance, Tracking Area
TAC Tracking Area Code
TAG Timing Advance Group
TAI Tracking Area Identity
TAU Tracking Area Update
TB Transport Block
TBS Transport Block Size
TBD To Be Defined
TCI Transmission Configuration Indicator
TCP Transmission Communication Protocol
TDD Time Division Duplex
TDM Time Division Multiplexing
TDMA Time Division Multiple Access
TE Terminal Equipment
TEID Tunnel End Point Identifier
TFT Traffic Flow Template
TMSI Temporary Mobile Subscriber Identity
TNL Transport Network Layer
TPC Transmit Power Control
TPMI Transmitted Precoding Matrix Indicator
TR Technical Report
TRP, TRxP Transmission Reception Point
TRS Tracking Reference Signal
TRx Transceiver
TS Technical Specifications, Technical Standard
TTI Transmission Time Interval
Tx Transmission, Transmitting, Transmitter
U-RNTI UTRAN Radio Network Temporary Identity
UART Universal Asynchronous Receiver and Transmitter
UCI Uplink Control Information
UE User Equipment
UDM Unified Data Management
UDP User Datagram Protocol
USDF Unstructured Data Storage Network Function
UICC Universal Integrated Circuit Card
UL Uplink
UM Unacknowledged Mode
UML Unified Modelling Language
UMTS Universal Mobile Telecommunications System
UP User Plane
UPF User Plane Function
URI Uniform Resource Identifier
URL Uniform Resource Locator
URLLC Ultra-Reliable and Low Latency
USB Universal Serial Bus
USIM Universal Subscriber Identity Module
USS UE-Specific search space
UTRA UMTS Terrestrial Radio Access
UTRAN Universal Terrestrial Radio Access Network
UwPTS Uplink Pilot Time Slot
V2I Vehicle-to-Infrastruction
V2P Vehicle-to-Pedestrian
V2V Vehicle-to-Vehicle
V2X Vehicle-to-everything
VIM Virtualized Infrastructure Manager
VL Virtual Link,
VLAN Virtual LAN, Virtual Local Area Network
VM Virtual Machine
VNF Virtualized Network Function
VNFFG VNF Forwarding Graph
VNFFGD VNF Forwarding Graph Descriptor
VNFM VNF Manager
VoIP Voice-over-IP, Voice-over-Internet Protocol
VPLMN Visited Public Land Mobile Network
VPN Virtual Private Network
VRB Virtual Resource Block
WiMAX Worldwide Interoperability for Microwave Access
WLAN Wireless Local Area Network
WMAN Wireless Metropolitan Area Network
WPAN Wireless Personal Area Network
X2-C X2-Control plane
X2-U X2-User plane
XML eXtensible Markup Language
XRES EXpected user RESponse
XOR eXclusive OR
ZC Zadoff-Chu
ZP Zero Po

What is claimed is:

1-20. (canceled)

21. An apparatus of a user equipment device (UE) device for configuring uplink transmission using more than four transmitters, the apparatus comprising processing circuitry coupled to storage for storing information associated with the configuring, the processing circuitry configured to:
detect received downlink control information (DCI) for configuring a transmission using more than four transmitters of the UE device;
decode a precoder rank indicator in the DCI, the precoder rank indicator signaling an uplink transmission using more than four transmitters of the UE device; and
decode a precoder indicator in the DCI for use in the uplink transmission by the UE device.

22. The apparatus of claim 21, wherein the precoder rank indicator signals a fully coherent codebook.

23. The apparatus of claim 21, wherein the number of transmitters is eight.

24. The apparatus of claim 21, wherein the precoder rank indicator is configured by received radio resource control (RRC) information.

25. The apparatus of claim 21, wherein a number of layers for the uplink transmission is signaled by the received RRC information.

26. The apparatus of claim 21, wherein the DCI further signals a modulation and coding scheme to apply to the uplink transmission.

27. The apparatus of claim 21, wherein the DCI further signals a redundancy version to apply to the uplink transmission.

28. A non-transitory computer-readable medium storing computer-executable instructions for configuring uplink transmission using more than four transmitters, which when executed by one or more processors result in performing operations comprising:
detecting received downlink control information (DCI) for configuring a transmission using more than four transmitters of the UE device;
decoding a precoder rank indicator in the DCI, the precoder rank indicator signaling an uplink transmission using more than four transmitters of the UE device; and
decoding a precoder indicator in the DCI for use in the uplink transmission by the UE device.

29. The non-transitory computer-readable medium of claim 28, wherein the precoder rank indicator signals a fully coherent codebook.

30. The non-transitory computer-readable medium of claim 28, wherein the precoder rank indicator is configured by received radio resource control (RRC) information.

31. The non-transitory computer-readable medium of claim 28, wherein a number of layers for the uplink transmission is signaled by the received RRC information.

32. The non-transitory computer-readable medium of claim 28, wherein the DCI further signals a modulation and coding scheme to apply to the uplink transmission.

33. The non-transitory computer-readable medium of claim 28, wherein the DCI further signals a redundancy version to apply to the uplink transmission.

34. A method for configuring uplink transmission using more than four transmitters, the method comprising:
detecting, by processing circuitry of a user equipment (UE) device, received downlink control information (DCI) for configuring a transmission using more than four transmitters of the UE device;
decoding, by the processing circuitry, a precoder rank indicator in the DCI, the precoder rank indicator signaling an uplink transmission using more than four transmitters of the UE device; and
decoding, by the processing circuitry, a precoder indicator in the DCI for use in the uplink transmission by the UE device.

35. The method of claim 34, wherein the precoder rank indicator signals a fully coherent codebook.

36. The method of claim 34, wherein the precoder rank indicator is configured by received radio resource control (RRC) information.

37. The method of claim 34, wherein a number of layers for the uplink transmission is signaled by the received RRC information.

38. The method of claim 34, wherein the DCI further signals a modulation and coding scheme to apply to the uplink transmission.

39. The method of claim 34, wherein the DCI further signals a redundancy version to apply to the uplink transmission.

40. The method of claim 34, wherein the number of transmitters is eight.
